(19) United States
(12) Patent Application Publication
(10) Pub. No.: US 2007/0255428 A1
(43) Pub. Date: Nov. 1, 2007

(54) Multifunction device, method of controlling multifunction device, control device, method of controlling control device, multifunction device control system, control program, and computer-readable storage medium

(75) Inventor: Yoshinori Nagata, Kitakatsuragi-gun (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/796,732

(22) Filed: Apr. 27, 2007

(30) Foreign Application Priority Data
May 1, 2006 (JP) 2006-127815

(51) Int. Cl. G05B 11/01

(52) U.S. Cl. 700/8

(57) ABSTRACT

A system which can control functions of a multifunction device in an integrative manner and can flexibly change the functions of the multifunction device. The multifunction device includes a computer including a CPU and a RAM and is connected to, is able to communicate with, and is controlled by one or more control devices. The multifunction device is provided with: a storage section which stores a program for multifunction device, which program is executable by the CPU; a program registration management application which stores the program supplied from the control device in the storage section; and a job manager which causes the CPU to execute the program stored in the storage section, in response to an instruction to execute the program supplied from the control device.

This Nonprovisional application claims priority under 35 U.S.C. § 119(a) on Patent Application No. 127815/2006 filed in Japan on May 1, 2006, the entire contents of which are hereby incorporated by reference.

### FIELD OF THE INVENTION

The present invention relates to a multifunction device control system in which a multifunction device is connected via a communications network with control devices that control the multifunction device.

### BACKGROUND OF THE INVENTION

There have been known multifunction devices each of which has plural functions such as copying, scanning, printing, and facsimile transmission. These days such a multifunction device is connected to a PC (Personal Computer) or the like via a communications network and executes various processes.

Document 1, for example, proposes an image processing device which includes: program storage means for obtaining an execution program from an outside via a network and storing the program; and processing means for processing image data by executing the execution program stored in the program storage means. According to Document 1, in this image processing device, it is unnecessary to store all execution programs in the program storage means of the image processing device in advance, and a program is obtained from a host computer as necessity arises and the program is executed.

On the other hand, in a system adopting Sharp OSA (Open Systems Architecture) having been proposed by the applicant of the present application, applications running on a PC cooperate with functions of a multifunction device, based on SOAP (Simple Object Access Protocol). The multifunction device can therefore operate as a part of a total application system. This makes it possible to easily construct a flexible service in which functions of a multifunction device are appropriately combined with functions of a PC (see Documents 2 and 3).

The aforesaid conventional art, however, is disadvantageous in that it is difficult to construct an integrative and flexible network system.

(Document 1) Japanese Laid-Open Patent Application No. 2001-156952 (published on Jun. 8, 2001)

(Document 2) ‘Digital Color Multifunction Device . . . ’ [online]. Sharp Corporation, date unknown [retrieved on Apr. 4, 2006]. Retrieved from the Internet: <URL: http://www.sharp.co.jp/products/mx4501fn/text/function.html>

(Document 3) Hisashi KOBAYASHI ‘Sharp Unveiled 12 Models of Business-Oriented Digital Full-Color Multifunction Devices’ [online]. ascii24.com, Nov. 24, 2005 [retrieved on Apr. 4, 2006]/Retrieved from the Internet: <URL: http://ascii24.com/news/i/hard/article/2005/11/24/659226-000.html>

### SUMMARY OF THE INVENTION

For example, according to Document 1, a host computer cannot control the execution of a program that a multifunction device obtains via a communications network. It is therefore difficult from the outside to control in an integrative manner a function achieved by various programs including a program obtained via a communications network.

In the meanwhile, according to Sharp OSA, while it is possible to allow a function of a multifunction device to cooperate with another PC, functions of the multifunction device are fixed and a new function cannot be added after the shipment. Alternatively, even if it is technically possible to add a new function, upgrade in a factory, e.g. replacement of a substrate and update of a program, is required and the user cannot perform the addition by himself/herself. The system based on the technology therefore lacks flexibility.

The present invention was done to solve the problems above, and the objective of the present invention is to provide a system providing functions for a multifunction device, which system can control functions of the multifunction device in an integrative manner and flexibly change the functions of the multifunction device.

To achieve the objective above, a multifunction device of the present invention, which includes a computer, is connected to and is able to communicate with one or more control devices, and is controlled by said one or more control devices, includes: a received program storage section which stores a program for multifunction device, the program being executable by the computer; program receiving means for receiving the program from said one or more control devices and storing the program in the received program storage section; and program calling means for causing the computer to execute the program stored in the received program storage section, in response to an instruction to execute the program, the instruction being supplied from said one or more control devices.

To achieve the objective above, a method of controlling a multifunction device of the present invention, which includes a computer, is connected with and able to communicate with one or more control devise, and is controlled by said one or more control devices, includes the steps of: receiving a program for multifunction device from said one or more control device and storing the program in a received program storage section; and in response to an instruction to execute the program, causing the computer to execute the program stored in the received program storage section.

According to the arrangement above, the program receiving means obtains, from the control device, a program for multifunction device which program is executable by the computer of the multifunction device, and the program is stored in the received program storage section. With this, the multifunction device can obtain from the control device a program that the multifunction device does not have, and the computer executes the obtained program so that the multifunction device can execute a new process which was not executable at the time of shipment.

Also, according to the arrangement above, the program calling means causes the computer to execute the program stored in the received program storage section, in response to an execution instruction supplied from the control device. This allows the control device to instruct the multifunction device to execute a process corresponding to the obtained program. It is therefore possible to realize a system which can control functions of the multifunction device in an integrative manner and flexibly change the functions of the multifunction device.

To achieve the objective above, a control device of the present invention, which is connected with and able to communicate with a multifunction device including a computer, includes: a transmission program storage section which stores a program for multifunction device, the program being executable by the computer of the multifunction device; program sending means for reading out the program from the transmission program storage section and sending the program to the multifunction device; and multifunction device control means for sending, to the multifunction device, an instruction to execute the program which is sent by the program sending means.

A method of controlling a control device of the present invention, which is connected to and able to communicate with a multifunction device including a computer, includes the steps of: reading out a program for multifunction device from a transmission program storage section and sending the program to the multifunction device; and sending, to the multifunction device, an instruction to execute the program sent by program sending means.

According to the arrangement above, the program sending means reads out, from the transmission program storage section, a program for multifunction device which program is executable by the computer of the multifunction device, and the program is sent to the multifunction device. This allows the control device to provide, to the multifunction device, a program that the multifunction device does not have. Also, the computer executes the program thus provided so that the multifunction device can execute a new process that the multifunction device could not execute at the time of shipment.

According to the arrangement above, furthermore, the multifunction device control means sends, to the multifunction device, an instruction to execute a program for multifunction device. This allows the control device to instruct the execution of the program sent to the multifunction device. It is therefore possible to realize a system which can control functions of the multifunction device in an integrative manner and can flexibly change the functions of the multifunction device.

To achieve the objective above, a multifunction device control system of the present invention includes: a multifunction device including a computer; and one or more control devices which are connected to and able to communicate with the multifunction device, each control device including: a transmission program storage section which stores a program for multifunction device, the program being executable by the computer of the multifunction device; program sending means for reading out the program from the transmission program storage section and sending the program to the multifunction device; and multifunction device control means for sending, to the multifunction device, an instruction to execute the program which is sent by the program sending means, the multifunction device including: a received program storage section which stores the program for multifunction device; program receiving means for receiving the program from said one or more control devices and storing the program in the received program storage section; and program calling means for causing the computer to execute the program stored in the received program storage section, in response to the instruction from said one or more control devices.

According to the arrangement above, it is possible to realize a system which can control functions of the multifunction device in an integrative manner and can flexibly change the functions of the multifunction device.

The means of the above-described multifunction device and control device may be realized by hardware or may be realized by causing a computer to execute a program. More specifically, a control program of the present invention causes a computer to function as the means of the aforesaid multifunction device or control device. A storage medium of the present invention stores the control program.

As the computer executes the aforesaid control program, the computer functions as the means of the aforesaid multifunction device or control device. On this account, as in the case of the aforesaid multifunction device and control device, it is possible to realize a system which can control functions of the multifunction device in an integrative manner and can flexibly change the functions of the multifunction device.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 relates to an embodiment of the present invention and is a block diagram showing a functional arrangement of a multifunction device.

FIG. 2 relates to the embodiment of the present invention and is a block diagram which outlines a multifunction device control system.

FIG. 3 relates to the embodiment of the present invention and is a block diagram showing a hardware arrangement of the multifunction device.

FIG. 4 relates to the embodiment of the present invention and is a plan view of an operation section of the multifunction device.

FIG. 5 relates to the embodiment of the present invention and is a block diagram showing a hardware arrangement of a control device.

FIG. 6 relates to the embodiment of the present invention and is a block diagram showing a functional arrangement of the control device.

FIG. 7 relates to the embodiment of the present invention and shows an example of a multifunction device program management table stored in a storage section of the control device.

FIG. 8 relates to the embodiment of the present invention and shows an example of a control instruction table stored in a control instruction table storage section of the control device.

FIG. 9 relates to the embodiment of the present invention and illustrates functions of an Open I/F layer.

FIG. 10 relates to the embodiment of the present invention and is a flowchart for illustrating the operation of the multifunction device control system.

FIG. 11 relates to a conventional art and is a timing chart showing the flow of an authentication process in case where communications are performed based solely on HTTP.

FIG. 12 relates to the embodiment of the present invention and is a timing chart for showing the flow of a login process.

FIG. 13 relates to the embodiment of the present invention and shows an example of a server selection screen.

FIG. 14 relates to the embodiment of the present invention and shows an example of a login screen.

FIG. 15 relates to the embodiment of the present invention and shows an example where the administrator inputs login information to the login screen.

FIG. 16 relates to the embodiment of the present invention and shows an example where a general user inputs login information to the login screen.

FIG. 17 relates to the embodiment of the present invention and is a flowchart showing a maintenance process of a program for multifunction device.

FIG. 18 relates to the embodiment of the present invention and shows an example of an administration menu screen.

FIG. 19 relates to the embodiment of the present invention and shows an example of the multifunction device program management table stored in the storage section of the multifunction device.

FIG. 20 relates to the embodiment of the present invention and is a block diagram showing a function arrangement of an OSA server layer after a program for multifunction device supplied from the control device is registered.

FIG. 21 relates to the embodiment of the present invention and shows an example of a completion notification screen which is displayed when the maintenance process of the program for multifunction device has been completed.

FIG. 22 relates to the embodiment of the present invention and is a flowchart showing the first half of a cooperated process in the multifunction device.

FIG. 23 relates to the embodiment of the present invention and is a flowchart showing the second half of the cooperated process in the multifunction device.

FIG. 24 relates to the embodiment of the present invention and shows an example of a process menu screen.

FIG. 25 relates to the embodiment of the present invention and shows a part of an event table stored in the storage section of the control device.

FIG. 26 relates to the embodiment of the present invention and is a timing chart showing the flow of data among blocks, when an execution instruction is supplied from the control device to the multifunction device.

FIG. 27 relates to the embodiment of the present invention and shows an example of the completion notification screen which is displayed when the cooperated process in the multifunction device has been completed.

FIG. 28 relates to the embodiment of the present invention and shows an example of a control device program management table, which is stored in the storage section of the control device.

### DESCRIPTION OF THE EMBODIMENTS

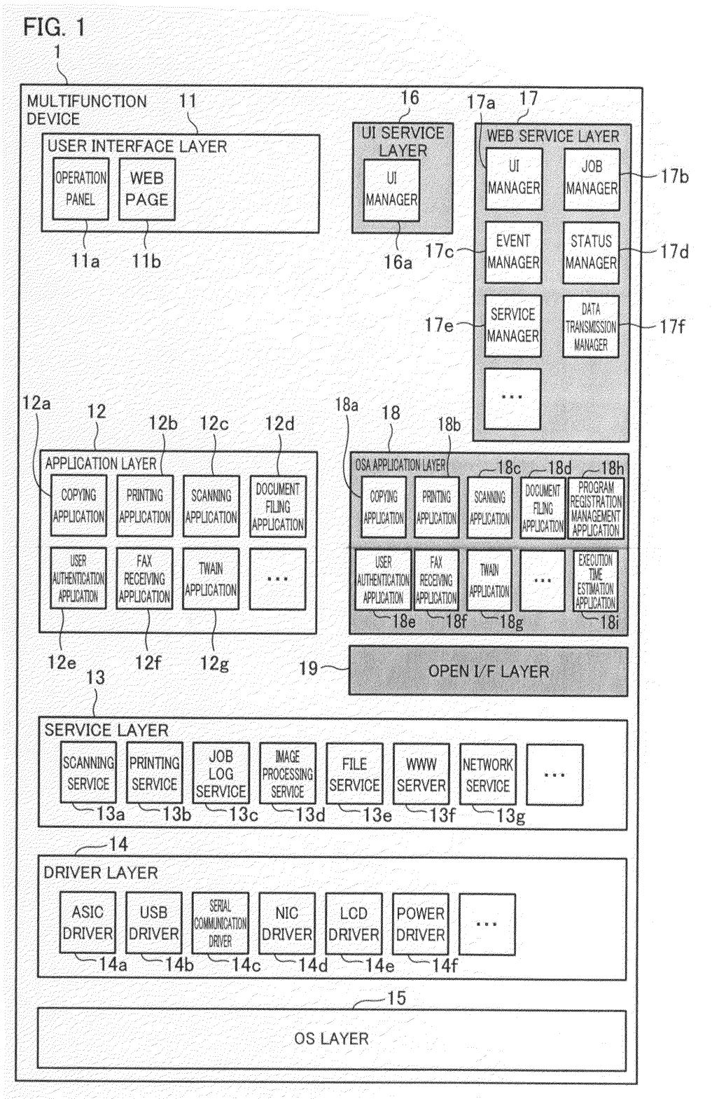

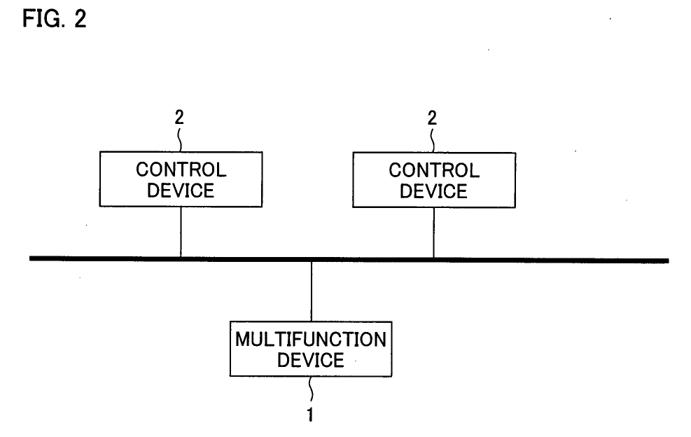

The following will describe an embodiment of the present invention with reference to FIGS. 1-28, which embodiment relates to a multifunction device control system. FIG. 2 outlines the multifunction device control system of the present embodiment.

As shown in FIG. 2, the multifunction device control system of the present embodiment includes a multifunction device 1 and plural control devices 2, and these devices are connected to one another by a communications network. As a matter of course, the number of multifunction device included in the multifunction device control system may be more than one, and the number of control device in the multifunction device control system may be one.

In the present embodiment, the control devices 2 provide, to the multifunction device 1, application programs (e.g. an OCR program and a translation program) that the multifunction device 1 is executable. With this, the multifunction device 1 can obtain and execute programs which are not installed therein at the time of shipment, as necessity arises. Also, even if a program is updated after the shipment, the multifunction device 1 can obtain the latest version of the program from the control devices 2 as necessity arises and execute the program.

The control devices 2 can control processes executed by the multifunction device 1, by sending an execution instruction to the multifunction device 1 over the communications network. Furthermore, the control devices 2 can instruct the multifunction device 1 to perform a cooperated process in which functions of the multifunction device 1 cooperate one another.

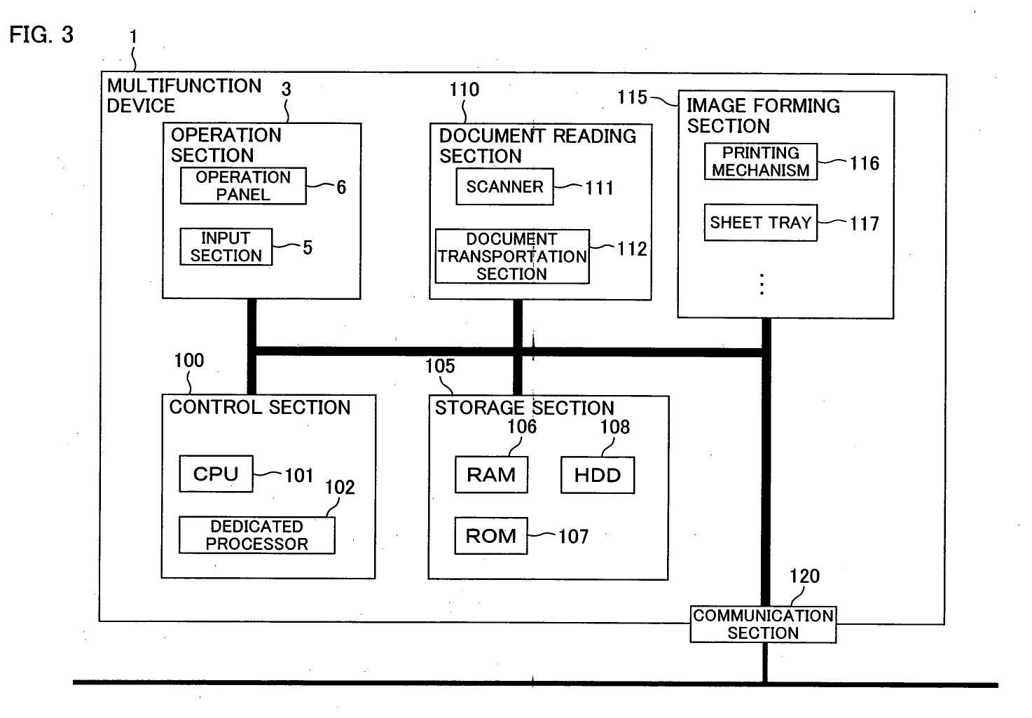

FIG. 3 is a block diagram showing a hardware arrangement of the multifunction device 1. As shown in FIG. 3, the multifunction device 1 includes an operation section 3, a control section (computer) 100, a storage section (computer) 105, a document reading section 110, an image forming section 115, and a communication section 120. These sections are connected with one another by a data bus.

The operation section 3 receives an input from the user and includes an operation panel 6 and an input section 5 which will be discussed later. The document reading section 110 includes a scanner 111 and a document transportation section 112, and can read out, as image data, texts and images printed on a document.

The image forming section 115 prints, on a sheet or the like, an image (texts/photos/graphics) corresponding to input image data. The image forming section 115 includes members such as a printing mechanism 116 and a sheet tray 117. The communication section 120 is an interface for communications with external devices such as the control devices 2.

The control section 100 includes a CPU 101 and a dedicated processor 102. The storage section 105 includes a RAM 106, a ROM 107, and an HDD 108.

In the multifunction device 1, various functions are achieved in such a manner that the CPU 101 of the control section 100 executes programs stored in the storage section 105. In other words, the CPU 102 executes the control program of the document reading section 110 so that a document reading process is executed. Also, the CPU 101 executes the control program of the image forming section 115 so that an image formation (printing) process is executed, and the CPU 101 executes the control program of the communication section 120 so that a communication process such as transmission of various types of data is executed. In addition, in the multifunction device 1, the CPU 101 executes an application program so that image processing such as OCR and translation is executed.

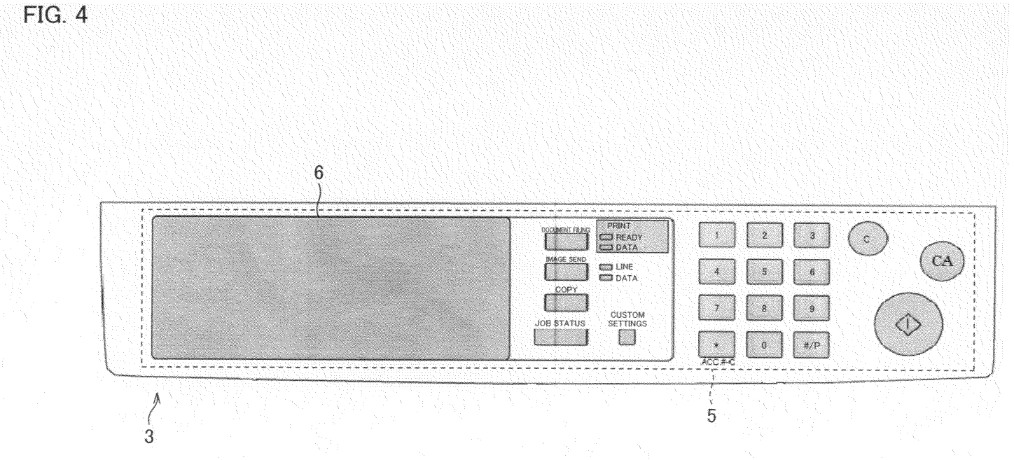

FIG. 4 is an enlarged view of the operation section 3 of the multifunction device 1. As shown in FIG. 4, the operation section 3 includes an operation panel (display section) 6 on which an operation screen for the user is displayed and an input section 5 which receives user input. Adopting a touch panel system, the operation panel 6 also functions as the input section 5.

The multifunction device 1 may be connectable to a UI device in place of or in addition to the operation section 3. In such a case, the operation screen is displayed on the UI device connected to the multifunction device 1.

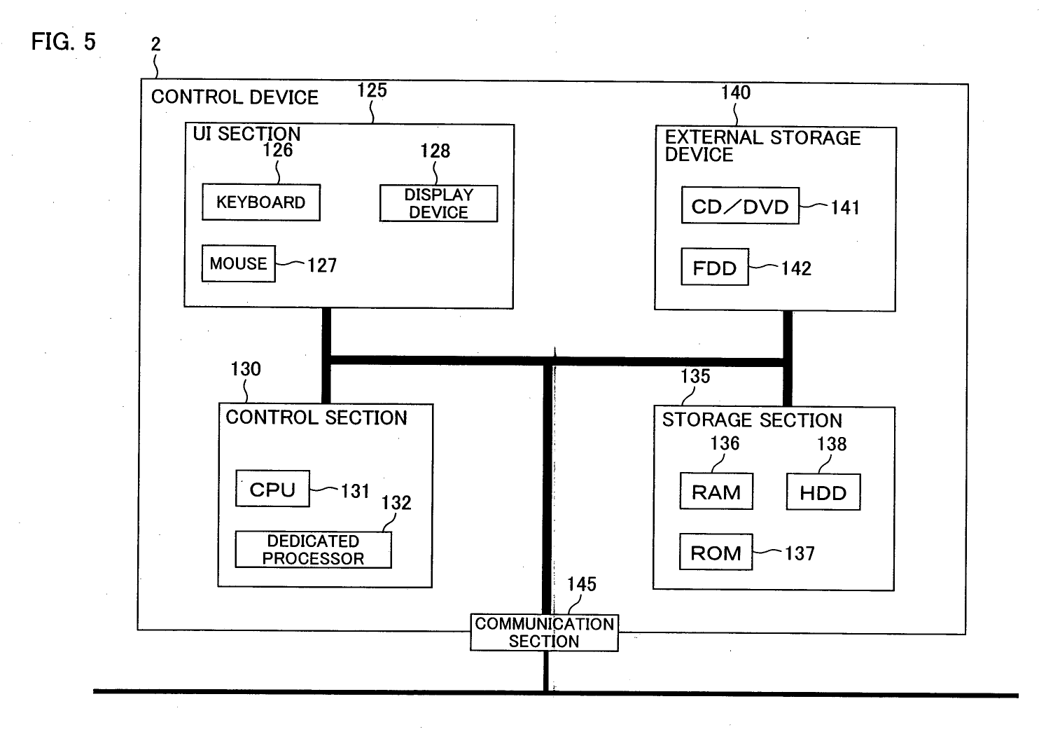

FIG. 5 is a block diagram showing a hardware arrangement of the control device 2. As shown in FIG. 5, the control device 2 is a computer and includes a UI section 125, a control section 130, a storage section 135, an external storage device 140, and a communication section 145. These sections are connected to one another by a data bus.

The UI section 125 receives user input and notifies the user of information, and includes a keyboard 126, a mouse 127, and a display device 128. The communication section 145 is an interface for communications with external devices such as the multifunction device 1.

The control section 130 includes a CPU 131 and a dedicated processor 132. The storage section 135 includes a RAM 136, a ROM 137, and an HDD 138. The external storage device 140 includes a CD/DVD 141 and a FDD 142.

In the control device 2, various functions are achieved in such a manner that the CPU 131 of the control section 130 executes functions stored in the storage section 135. In other words, the CPU 131 executes the control program of the UI section 125 so that a process to receive information input from the user and a process to notify the user of information are executed. Also, the CPU 131 executes the control program of the communication section 145 so that a communication process such as transmission of various types of data is executed. Furthermore, in the control device 2, the CPU 101 executes an application program so that image processing such as OCR and translation is executed.

Examples of the communications network by which the multifunction device 1 is connected to the control devices 2 include the Internet, telephone lines, serial cables, and other wired and wireless lines.

To control various functions of the multifunction device 1, the control device 2 may use one or more Web services provided by the multifunction device 1. An web service is a program process which allows a function to be used from outside over a network, and is typically based on SOAP.

In the meanwhile, the multifunction device 1 accesses the control device 2 which is an Web server, obtains data of an operation screen from the control device 2, and displays the obtained operation screen on the operation panel 6. In short, the multifunction device 1 can interact with the user. As a result, the multifunction device 1 can therefore display an operation screen only by requesting the control device 2 to supply the operation screen data, and hence the multifunction device 1 is not required to manage operation screens and data thereof.

With this arrangement, the multifunction device control system of the present embodiment has a high flexibility because it is possible from the control devices 2 to add a new function to the multifunction device 1 and to freely control the operation of the multifunction device 1.

As described below, any types of the multifunction device 1 adopts same APIs (Application Program Interfaces; control instructions) to the outside. The control devices 2 can therefore output same control instructions to any types of multifunction device 1, and this makes it easy to develop programs embedded in the control devices 2. The API is a group of rules (functions) stipulating relations between instructions which can be used for software development and procedures executed by the respective instructions.

The multifunction device 1 and the control devices 2 use HTTP or HTTPS supporting SSL (Secure Socket Layer), for communications regarding requests/responses of operation screen data. HTTPS is suitable for improving security as compared to HTTP. Examples of markup languages used for such communications are HTML (Hypertext Markup Language), XML (eXtensible Markup Language), WML (Wireless Markup Language), and XHTML (eXtensible HyperText Markup Language) and/or other languages.

XML is a descriptive language with document structure, which allows data transmissions as easy as HTML. XML is advantageous in (a) that the user can define the meaning of a character string in a document, (b) not being dependent on any particular software, and (c) being easily programmable, and the like.

In the meanwhile, control instructions by which the control devices 2 control the multifunction device 1 are transmitted by means of a protocol for communications between objects. An example of such a protocol is SOAP (Simple Object Access Protocol) using a markup language such as XML. SOAP is an XML-based or HTTP-based protocol for calling data and services, and enables plural systems to cooperate one another.

The following will discuss how the control device 2 and the multifunction devices 1 are arranged.

(Control Device)

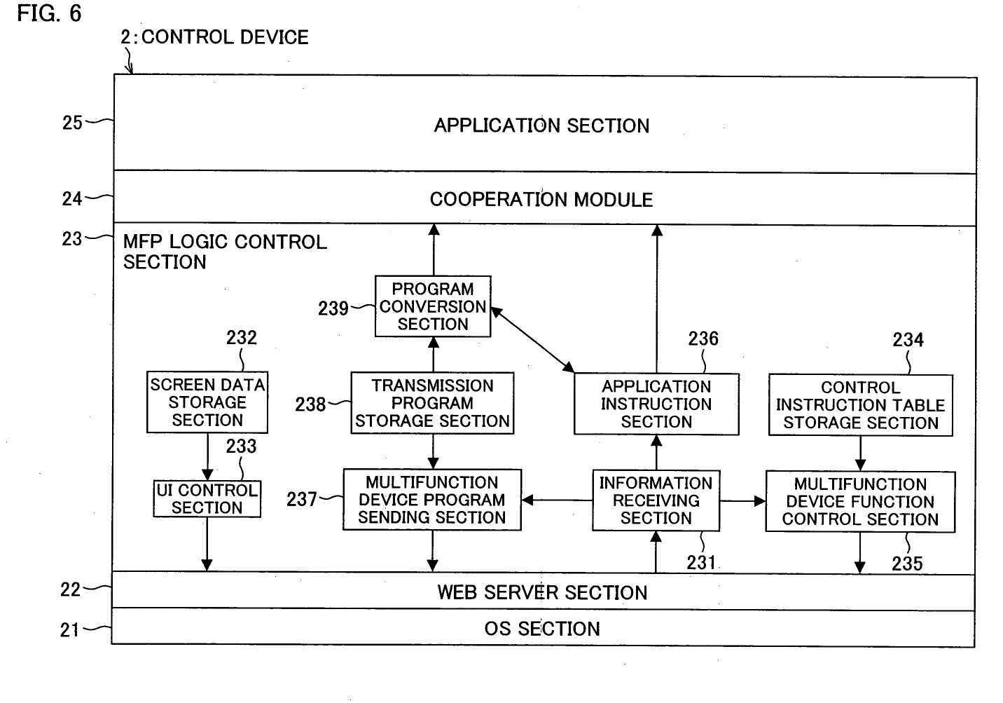

FIG. 6 is a block diagram showing a functional arrangement of the control device 2 of the present embodiment. As shown in FIG. 6, the control device 2 includes an OS section 21, an Web server section 22, an MFP control logic section 23, an cooperation module 24, and an application section 25. These sections are realized by the cooperation of hardware including the control section 130 and the storage section 135 shown in FIG. 5 and software which is programs stored in the storage section 135.

The OS section 21 is a block which controls a computer system and performs processes in accordance with an operation system (OS) that provides a basic user operation environment. Examples of the OS include Windows® and Linux®.

The Web server section 22 performs communications based on a protocol such as HTTP (HyperText Transfer Protocol)) (or HTTPS) and SOAP (Simple Object Access Protocol). The Web server section 22 receives an HTTP request from the multifunction device 1, and returns an HTTP response corresponding to the supplied HTTP request. The Web server section 22 is, for example, a block which operates in accordance with software such as Apache.

The MFP control logic section 23 controls the operation screen (UI) of the multifunction device 1 and various functions of the multifunction device 1, and the MFP control logic section 23 provides a program to the multifunction device 1. The MFP control logic section 23 includes an information receiving section 231, a screen data storage section 232, a UI control section 233, a control instruction table storage section 234, a multifunction device function control section (multifunction device control means) 235, an application instruction section 236, a multifunction device program sending section (program transmission means) 237, a transmission program storage section (transmission program storage means) 238, and a program conversion section (program conversion means) 239.

The screen data storage section 232 stores data of various operation screens displayed on the operation panel 6 of the multifunction device 1.

In response to an instruction from the information receiving section 231, the UI control section 233 reads out operation screen data from the screen data storage section 232 and supplies the data to the multifunction device 1 via the Web server section 22. This supply of the operation screen data from the UI control section 233 to the multifunction device 1 is carried out based on HTTP (or HTTPS).

The control instruction table storage section 234 stores a control instruction table in which a content of a process to be executed by the multifunction device 1 is associated with a control instruction (including an execution instruction) that the multifunction device 1 can receive, which instruction is used for executing the process with the aforesaid content.

In the control instruction table, for example, a process “scanning” is associated with control instructions (execution instructions) “JobCreate”, “ExecuteScan”, and “JobClose”. The control instruction table also defines the order of output of control instructions, in case where one process is associated with plural control instructions.

As described later, a control instruction indicated in the control instruction table is a group of commands for calling APIs (first APIs) that the Open I/F layer 19 of the multifunction device 1 discloses to the outside. Such commands are shared among all types of the multifunction devices 1.

In response to an instruction from the information receiving section 231, the multifunction device function control section 235 reads out, from the control instruction table storage section 234, a control instruction vis-à-vis the multifunction device 1, and sends the control instruction to the multifunction device 1 via the Web server section 22. The supply of the control instruction from the multifunction device function control section 235 to the multifunction device 1 is carried out based on SOAP.

The control instruction supplied from the multifunction device function control section 235 instructs the multifunction device 1 to execute processes that the multifunction device 1 is executable. Receiving the control instruction, the multifunction device 1 causes the CPU 101 to execute a program corresponding to the control instruction, so as to execute a process based on the functions that the multifunction device 1 has. In other words, the control instruction supplied from the multifunction device function control section 235 instructs the multifunction device 1 to execute a program.

In response to an instruction from the information receiving section 231, the application instruction section 236 instructs the application section 25 to start processes based on an application program.

The transmission program storage section 238 stores plural programs for multifunction device, which are executable by the CPU 101 of the multifunction device 1. The programs for multifunction device are not limited to any particular types. Examples of the programs include a tilt correction program by which tilt of a scanned image is corrected, an OCR program by which character recognition of a scanned image is carried out, and an English-Japanese translation program by which an English text obtained by character recognition is translated into a Japanese text.

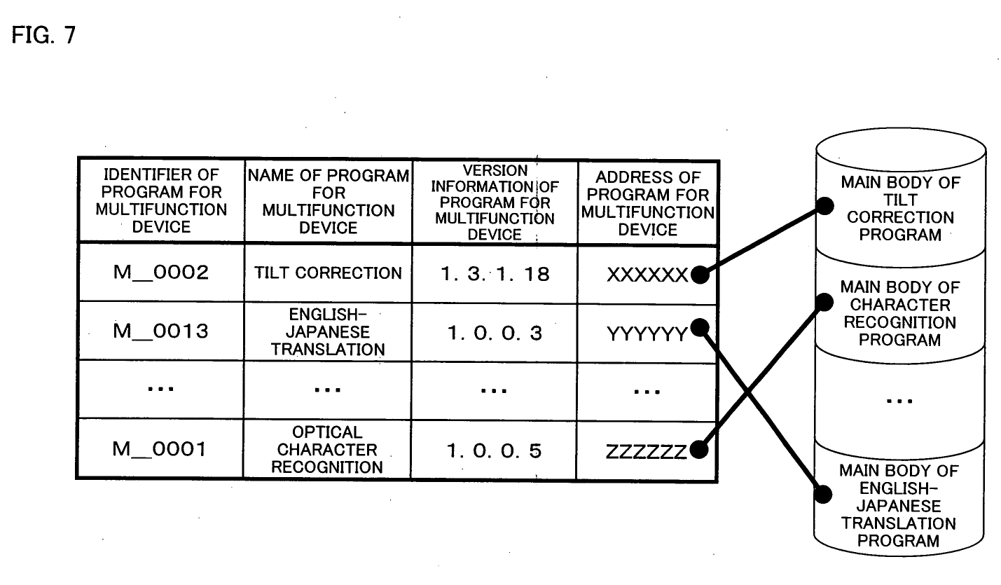

The transmission program storage section 238 further includes a multifunction device program management table in order to manage the locations of the aforesaid programs for multifunction device and also to manage version information. FIG. 7 shows an example of the multifunction device program management table. As shown in FIG. 7, the multifunction device program management table lists, for each program for multifunction device, the identifier of the program, the name of the program, the version information of the program, and the address of the program.

In response to an instruction from the information receiving section 231, the multifunction device program transmission section 237 reads out a program for multifunction device from the transmission program storage section 238 and sends the program to the multifunction device 1 via the Web server section 22.

In response to an instruction from the information receiving section 231, the program conversion section 239 reads out a program for multifunction device from the transmission program storage section 238, and converts the program into a program for control device, which program is executable by the CPU 131 of the control device 2 in which that program conversion section 239 is provided. The program conversion section 239 then stores the program after the conversion in the storage section 135. After being stored in the storage section 135, this program for control device functions as a part of the application section 25.

The information receiving section 231 receives information from the multifunction device 1 via the Web server section 22, and instructs the UI control section 233, the application instruction section 236, the multifunction device function control section 235, the multifunction device program sending section 237, and the program conversion section 239 to execute processes based on the information thus received. Examples of the types of the information that the information receiving section 231 receives from the multifunction device 1 include (1) request to transmit operation screen data, (2) selected item information which indicates which item is selected in an operation screen by the user, (3) input information (e.g. login information) which is input to an operation screen by the user, (4) request for execution of a process using applications by the application section 25, (5) request to transmit a program for multifunction device, (6) rejection notification which notifies that the execution of a program for multifunction device has been rejected in the multifunction device 1 and the rejected program, and (7) a completion notification which is supplied from the multifunction device 1 after a process is executed in the multifunction device 1.

Examples of the operation screen for the request (1) include an executed process selection screen which allows the user to select a process to be executed by the multifunction device 1 and a login screen for user authentication. Receiving the request (1), the information receiving section 231 instructs the UI control section 233 to send the requested operation screen data.

The information (2) includes, for example, a type of a process selected by using the executed process selection screen. Receiving the information (2), the information receiving section 231 instructs the multifunction device function control section 235 to send, to the multifunction device 1, an instruction to execute the selected process. For example, in case where the user selects a scanning process, the information receiving section 231 having received the selected process information which indicates that the scanning process has been selected instructs the multifunction device function control section 235 to send an instruction to execute the scanning process to the multifunction device 1.

The input information (3) includes authentication information such as a user ID and a password. Receiving the authentication information, the information receiving section 231 inputs the authentication information to the user authentication section (not illustrated) of the application section 25, and instructs the user authentication section to determine whether the user who input the information is one of authenticated users, with reference to the authentication information.

The request (4) is, for example, a request to execute a process to authenticate the user by using an authentication application and a request to execute a tabulation process using an event tabulation application. The aforesaid execution request (4) that the information receiving section 231 receives is not limited to them, and the request (4) may be any types of information which is optionally (or regularly) supplied from the multifunction device 1 and based on which the application section 25 carries out a particular process. Receiving the request (4), the information receiving section 231 instructs the application instruction section 236 to activate a user authentication section or a tabulation process section (which are not illustrated) of the application section 25.

Also, receiving the request (5), the information receiving section 231 instructs the multifunction device program sending section 237 to send a program for multifunction device to the multifunction device 1. Receiving the notification (6), the information receiving section 231 instructs the program conversion section 239 to generate, based on the supplied program for multifunction device, a program for control device, which program replaces the program having been rejected in the multifunction device 1. Receiving the notification (7), the information receiving section 231 instructs the multifunction device function control section 235 to send, to the multifunction device 1, an instruction to execute a subsequent process.

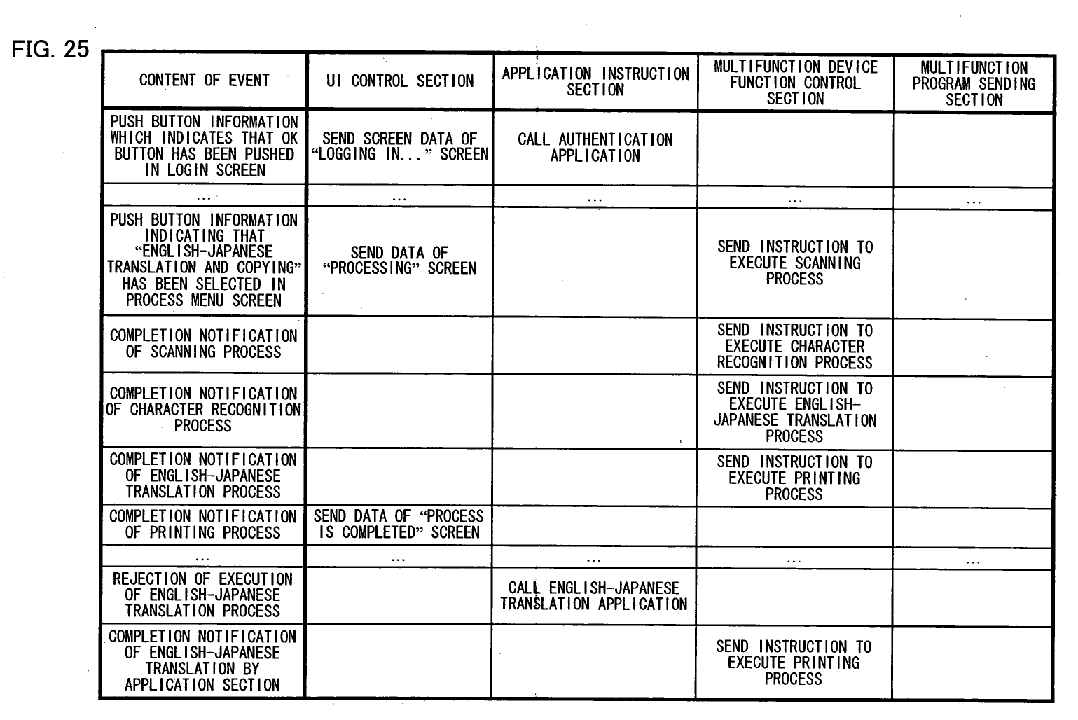

The information receiving section 231 issues those instructions based on an event table stored in the storage section 105. FIG. 25 shows a part of the event table. As shown in FIG. 25, the event table indicates information that the information receiving means receives and the target and content of an instruction in response to the information.

The application section 25 is a block to perform processes in accordance with various application programs. The processes are carried out in such a manner that the CPU 131 executes application programs stored in the storage section 135. The application section 25 operates in accordance with, for example, an authentication application for determining whether or not a user has been registered in advance, a document management application for storing and managing image data, and an event tabulation application that performs tabulation of events executed by the multifunction device 1.

The cooperation module 24 is a module to connect the application section 25 with the MFP control logic section 23. The cooperation module 24 forwards an instruction from the application instruction section 236 to the application section 25, and also forwards an instruction from the application section 25 to the device control section 235.

(Multifunction Device)

The following will describe the multifunction device 1. As shown in FIG. 1, the multifunction device 1 includes a user interface layer 11, an application layer 12, a service layer 13, a driver layer 14, an OS layer 15, a UI service layer 16, an Web service layer 17, an OSA application layer 18, and an Open I/F layer 19. These layers and blocks included therein are realized by cooperation of hardware including the control section 100 and the storage section 105 shown in FIG. 3 with software including the programs stored in the storage section 105.

The user interface layer 11 is provided for allowing the user to operate the multifunction device 1. The user interface layer 11 stores an operation screen (unique operation screen) unique to each type of multifunction device 1, and causes the operation panel 6 to display the unique operation screen. The user inputs to the unique operation screen an instruction to execute a desired function, so as to control the multifunction device 1.

The user interface layer 11 has an operation panel section 11a that sends, to the application layer 12, information having been input to the operation screen of the multifunction device 1.

A Web page section 11b sends, to the application layer 12, information having been input to a Web page.

The application layer 12 operates in accordance with application programs which cause elemental processes of the multifunction device 1 to cooperate with one another and execute them. Examples of the elemental processes include a scanning process which is executed by controlling the document reading section 110 shown in FIG. 3, a printing process which is executed by controlling the image forming section 115, an image process based on an application program, and a network process which is executed by controlling the communication section 120. A cooperated process is achieved by combining these elemental processes. In the present embodiment, execution of a cooperated process is instructed by the user.

Examples of a cooperated process in which elemental processes are combined include a copying process which is a combination of a scanning process, image process, and printing process, and a translation copying process which is a combination of the scanning process, character recognition (OCR) process, and an English-Japanese translation process. Hereinafter, a cooperated process is distinguished from an elemental process.

The application layer 12 of the present embodiment includes applications such as: a copying application 12a for executing/controlling a copying process which is a cooperated process; a printing application 12b for executing/controlling a printing process; an image transmission application 12c for executing/controlling a process to transmit scanned image data to an external device (i.e. image transmission process); a document filing application 12d for executing/controlling a document filing process; a user authentication application 12e for executing/controlling a user authentication process; a facsimile receiving application 12f for executing/controlling a facsimile receiving process; and a TWAIN application 12g for executing/controlling a TWAIN process.

The service layer 13 is provided directly below the application layer 12, and controls various elemental processes of the multifunction device 1 in response to instructions from the application layer 12.

The service layer 13 of the present embodiment has services such as: a scanning service 13a for executing a scanning process which is an elemental process; a printing service 13b for executing a printing process; a job log service 13c for performing information management of each job; an image processing service 13d for executing an image formation process such as image generation; a file service 13e for controlling an image management process; a WWW server service 13f for controlling a process for remote access via a Web page; and a network service 13g for controlling a process for communication operations utilizing LAN, telephone lines, or the like.

The driver layer 14 is provided below the service layer 13, and controls the hardware of the multifunction device 1 in order to execute the aforesaid elemental processes. The sections of the service layer 13 operate in accordance with driver programs by which pieces of the hardware of the multifunction device 1 are controlled.

The driver layer 14 of the present embodiment has drivers such as: an ASIC driver 14a related to image formation; a USB driver 14b for performing USB communications; a serial communication driver 14c for performing serial communications; an NIC driver 14d for LAN communications; an LCD driver 14e for controlling image display on the operation panel 6; and a power driver 14f for power management.

The OS layer 15 is provided directly below the driver layer 14 and constitutes the operating system.

The user interface layer 11, application layer 12, service layer 13, driver layer 14, and OS layer 15 operate in accordance with software unique to each type of the multifunction device 1, and hence these layers are different depending on the type of the multifunction device 1. With these layers, the multifunction device 1 can directly receive instructions from the user without the intermediary of the communications network, and can operate in accordance with the instructions.

In case where only those layers unique to the multifunction device 1 are provided, the control devices 2 which control this multifunction device 1 are required to generate control instructions for each type of multifunction device 1, and this requirement is troublesome. In consideration of this problem, the multifunction device 1 of the present embodiment is provided with the following layers which can accept shared control instructions from an external control device 2.

The UI service layer 16 obtains operation screen data from the control device 2 by means of HTTP (or HTTPS), and causes the operation panel 6 to display an operation screen corresponding to the obtained operation screen data. The UI service layer 16 may function as a general-purpose Web browser.

The UI service layer 16 and the user interface layer 11 allow the user to use a normal operation mode and an open system mode. In the normal operation mode, an operation screen (displayed by the user interface layer 11) unique to the multifunction device 1 is operated so that a function corresponding to the operation is executed by the multifunction device 1. The open system mode uses a network resource (e.g. application of RCD).

The UI service layer 16 is provided with a UI manager 16a which controls how the UI (operation screen) supplied from the control device 2 is displayed.

The UI service layer 16 sends, by means of HTTP (or HTTPS), transmission request information which requests operation screen data, to the control device 2 specified by the address information. The UI manager 16a then instructs the operation panel 6 to display the operation screen based on the operation screen data which has been supplied in response. In this manner, the UI manager functions as UI processing means that receives data of an operation screen from the control device 2 and instructs the operation panel 6 to display the operation screen corresponding to the supplied data.

Also, the UI manager 16a sends, to the control device 2 and by means of HTTP (or HTTPS), push button information which indicates the button having been pushed on the operation screen, obtains new operation data in response to the push button information, and causes the operation panel 6 to display the operation screen corresponding to the data. In short, the UI manager 16a functions as information notification means which notifies the control device 2 of various types of information obtained from the user.

The Web service layer 17 receives a control instruction from the control device 2 by means of SOAP, and calls an appropriate module of the OSA application layer 18, which module corresponds to the control instruction. Also, the Web service layer 17 generates a SOAP command indicating the information supplied from the OSA application layer 18, and sends the SOAP command to the control device 2. The Web service layer 17 stores control instructions in association with modules of the OSA application layer 18, which modules correspond to the respective types of control indicated by the control instructions. An appropriate module is called in accordance with the stored content.

The Web service layer 17 of the present embodiment includes: a UI manager 17a which processes Web services in regard to UI control; a job manager 17b which deals with Web services in regard to UI control; an event manager 17c for processing Web services in regard of an event transmission request; a status manager 17d for processing Web services in regard of status control of jobs and devices; a service manager 17e for registering information in regard of the OSA application layer 18; a data transmission manager 17f for processing Web services in regard of transmission and reception of job data; and the like.

The OSA application layer 18 is a layer to control the aforesaid cooperated process, and outputs, to the Open I/F layer 19, first APIs (first control commands) included in a control instruction which instructs to execute a process and is supplied from the control device 2. As described later, APIs available in (disclosed to) the Open I/F layer 19 do not depend on the type of the multifunction device 1. On this account, the OSA application layer 18 is not required to change the program codes to support different types of multifunction devices 1.

The OSA application layer 18 of the present embodiment includes: a copying application 18a for executing/controlling a copying process; a printing application 18b for executing/controlling a printing process; a scanning application 18c for executing/controlling a function to transmit scanned image data to an external device; a document filing application 18d for executing/controlling a document filing process; a user authentication application 18e for executing/controlling a user authentication process; a facsimile receiving application 18f for executing/controlling a facsimile receiving process; a TWAIN application 18g for executing/controlling a TWAIN process; a program registration management application (program receiving means) for registering and managing an application program downloaded from the control device 2; an execution time estimation application 18i (execution time estimation means) for estimating time required for execution of a process; or the like.

The Open I/F layer 19 discloses, to the OSA application layer 18, first APIs for controlling the service layer 13. The Open I/F layer 19 receives first control commends for calling first APIs from the OSA application layer 18, and converts the supplied first control commands into second control commands that the service layer 13 can receive.

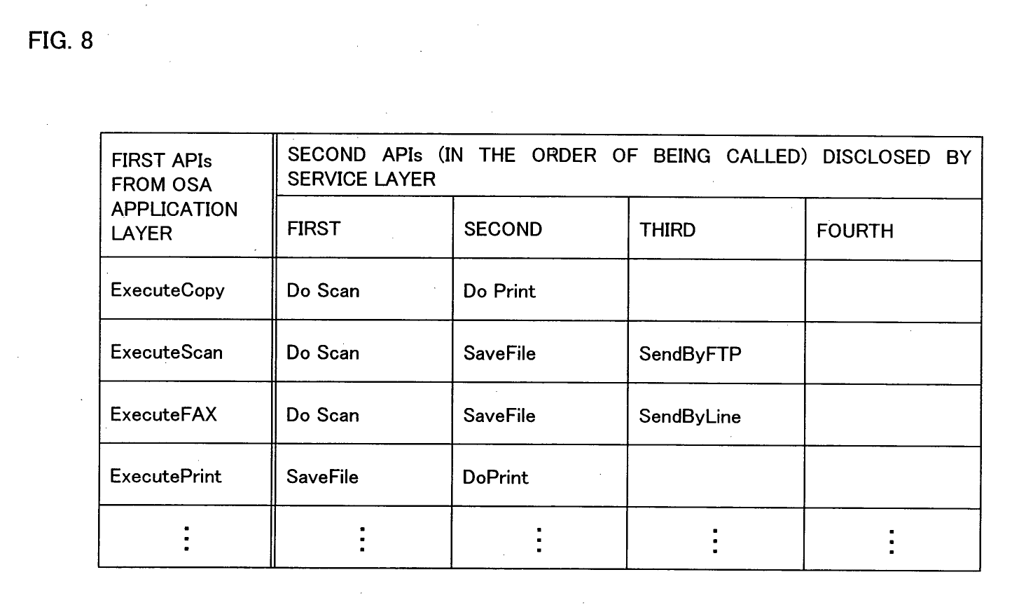

The Open I/F layer 19 is provided with a command conversion table storage section (command conversion table storage means; not illustrated) which stores a command conversion table (command corresponding information) in which first control commands supplied from the OSA application layer 18 are associated with respective second control commands for calling second APIs that are disclosed to the outside by the service layer 13. In accordance with the conversion table, the Open I/F layer 19 calls second APIs that the service layer 13 discloses. FIG. 8 shows an example of the command conversion table stored in the Open I/F layer 19.

In the Open I/F layer 19, the first APIs disclosed to the OSA application layer 18 are shared among all types of the multifunction devices 1. As a result of this, a method which is disclosed to external devices by the Web service layer 17 can be commonly defined irrespective of the types of the multifunction devices 1, without changing the program codes of the OSA application layer 18. In other words, each control device 2 can control the Web service layer 17 by means of a common method, irrespective of the type of the multifunction device 1.

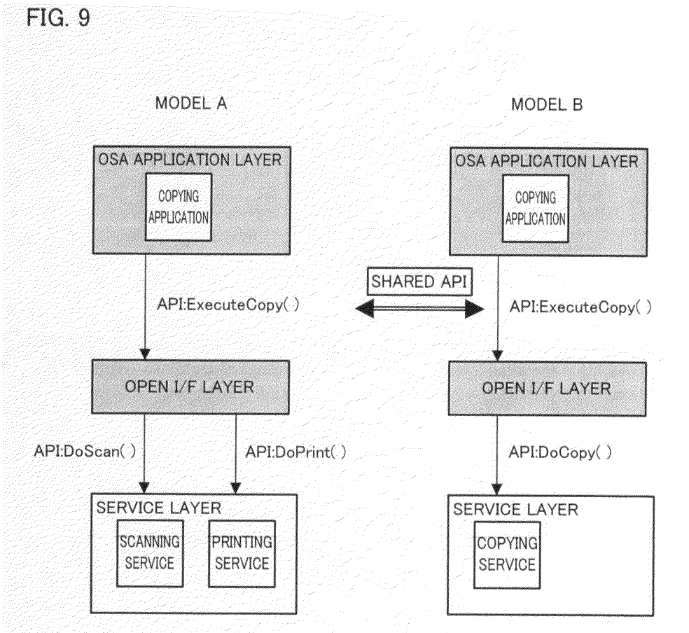

FIG. 9 illustrates the functions of the Open I/F layer 19. In this figure, a model-A multifunction device 1 has a scanning service 13a and a printing service 13b, as the service layer 13. In such a case, as a command corresponding table, the Open I/F layer 19 of the model-A multifunction device 1 stores the first API (first control command) ‘Execute Copy’ in association with the second APIs (second control commands) ‘Do Scan’ and ‘Do Print’. Therefore, receiving the first API (first control command) ‘Execute Copy’, the Open I/F layer 19 causes the multifunction device 1 to perform the scanning service 13a and printing service 13b in accordance with the second APIs (second control commands) obtained as a result of the conversion.

On the other hand, a model-B multifunction device 1 has a copying service as the service layer 13. In this case, as a command corresponding table, the Open I/F layer 19 of the model-B multifunction device 1 stores a first API (first control command) ‘Execute Copy’ in association with a second API (second control command) ‘Do Copy’. Therefore, receiving the first API (first control command) ‘Execute Copy’, the Open I/F layer 19 causes the multifunction device 1 to execute the copying service in accordance with the second API (second control command) obtained as a result of the conversion.

As described above, the Open I/F layer 19 allows the control devices 2 and the OSA application layer 18 to instruct the execution of the copying using the shared API (control command) ‘Execute Copy’, irrespective of the type of the multifunction device. That is, the control devices 2 and the OSA application layer 18 can instruct the execution of services using shared control instructions and first APIs (first control commands), even if the service layers are different depending on the type of multifunction device 1. It is therefore unnecessary to use different control instructions and first APIs (first control commands) corresponding to the respective types of multifunction devices 1, and hence programs for the control devices 2 and the OSA application layer 18 can be easily developed.

(Overall Operation of Multifunction Device Control System)

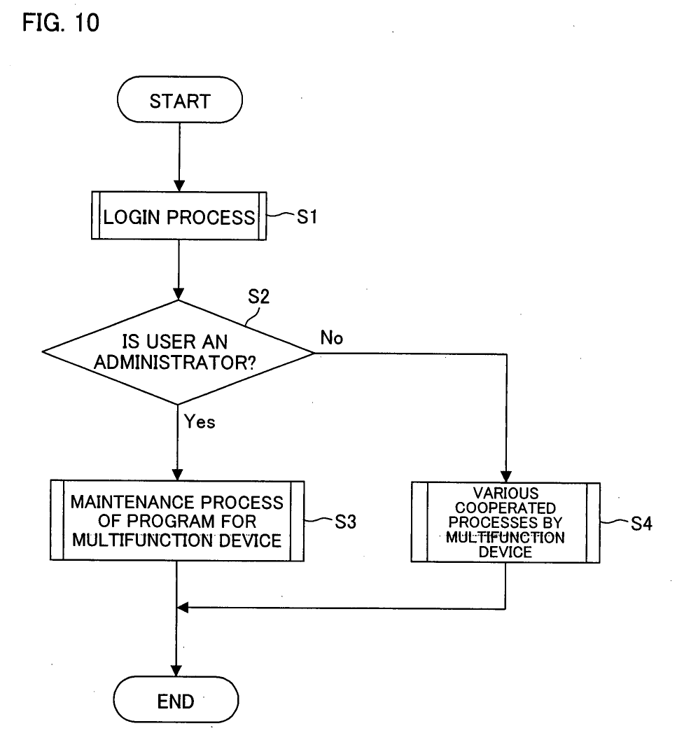

The following now outlines the operation of the multifunction device control system. FIG. 10 is a flowchart which outlines the operation of the multifunction device control system of the present embodiment.

As shown in FIG. 10, first, a login process for the user who uses the multifunction device 1 is carried out (S1). In the present case, the user is authenticated not by the multifunction device 1 but by the control device 2. Each multifunction device 1 is therefore not required to manage user information, even if a multifunction device control system includes plural multifunction devices 1.

Subsequently, the control device 2 determines whether the user using the multifunction device 1 is an administrator (S2). If the user is an administrator, the flow proceeds to the step S3 and a process to perform maintenance of a program for multifunction device is carried out. On the other hand, if the user is not an administrator but a general user, the flow goes to the step S4 and the multifunction device 1 performs cooperated processes such as copying and English-Japanese translation.

Details of the steps will be given below.

(Login Process)

Details of the aforesaid login process in the step S1 will be given first.

In the multifunction device control system of the present embodiment, the login process is executed by cooperation of the multifunction device 1 and an authentication application of the control devices 2. In other words, as described above, an authentication process to determine whether the user is an authenticated user is carried out by the control device 2, based on login information which has been input to the multifunction device 1 by the user.

Before discussing the login process in the multifunction device control system of the present embodiment, a comparative example in regard to a conventional technology will be explained.

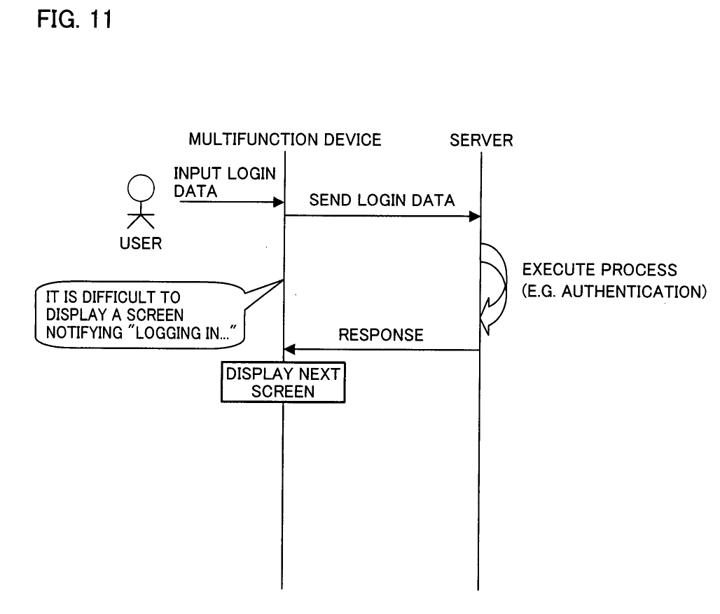

FIG. 11 shows the flow of an authentication process in a comparative example in which communications are carried out based only on HTTP. In HTTP, an HTTP request (request) and an HTTP response (response) are paired for communications. That is to say, when a client sends an HTTP request to a server, the server returns, to the client, the HTTP response corresponding to the HTTP request. In this manner, a server cannot send data to a client in the absence of an HTTP request, whereas a client cannot receive data from a server without sending an HTTP request to the server.

As shown in FIG. 11, in the comparative example, a multifunction device 1 (client) sends login data to a server. In response to the supplied data, the server sends data of a next operation screen to the multifunction device 1, after an authentication process is finished. In this example, the user cannot see the next screen until the authentication process is finished. This may induce anxiety about if the authentication process is properly carried out or not. It is therefore necessary to display, on the operation panel 6 of the multifunction device 1, a screen which shows, for example, a message “logging in . . . ”. In the comparative example, however, data of the next operation screen cannot be sent if the screen showing the message “logging in . . . ” is sent in response to the supply of the login data. This is because there is no request from the multifunction device 1.

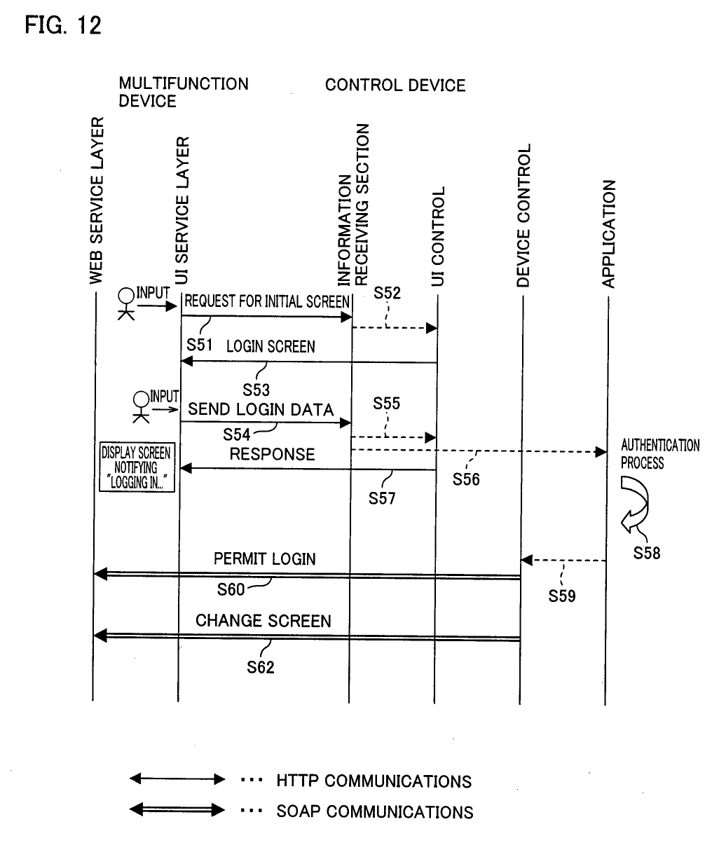

According to the present embodiment, an operation screen on the operation panel 6 of the multifunction device 1 can be switched to another operation screen while the application section 25 of the control device 2 performs a process in response to an HTTP request from the multifunction device 1. FIG. 12 is a timing chart of the login process in the present embodiment.

First, in the multifunction device 1, in order to allow the user to specify, among control devices 2 on the network, a control device 2 to be instructed to perform the login process, the UI manager 16a of the UI service layer 16 causes the operation panel 6 to display a server selection screen in which list of control devices 2 are shown to prompt the user to select a control device 2.

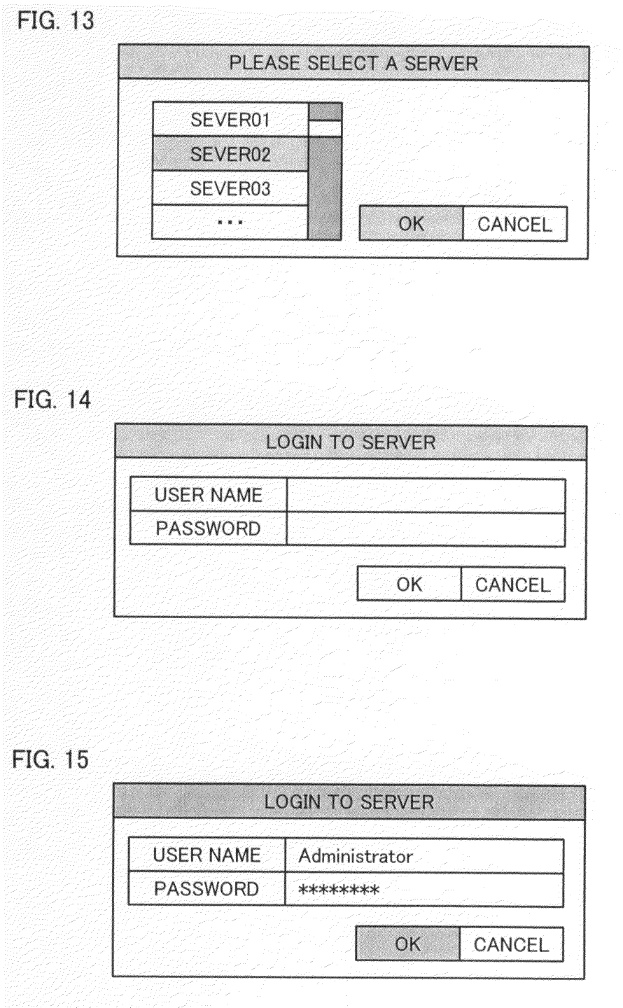

The user selects one of the control devices 2 to which the execution of the login process will instructed. FIG. 13 shows an example of the server selection screen, when the user has selected a control device 2.

Subsequently, in the multifunction device 1, the UI manager 16a of the UI service layer 16 sends, to the control device 2 having been selected by the user, a request of transmission of login screen data (S51).

In the control device 2 having received the request, the information receiving section 231 instructs the UI control section 233 to send the login screen data to the multifunction device 1 (S52), and the UI control section 233 searches the screen data storage section 232 for the login screen data, and returns the data to the multifunction device 1 (S53).

In the multifunction device 1, the UI manager 16a of the UI service layer 16 displays the login screen based on the supplied screen data. FIG. 14 shows an example of the login screen.

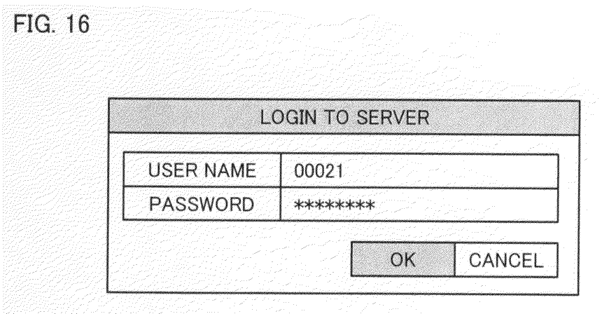

In response to this, the user inputs login data (user name and password) by using the operation panel 6 or the input section 5, and pushes the OK button. FIG. 15 shows an example of the login screen when an administrator inputs login information. FIG. 16 show an example of the login screen when a general user inputs login information. In response to the input, the UI manager 16a sends, to the control device 2, the login data thus input and push button information indicating that the OK button has been pushed (S54).

Subsequently, receiving the push button information, the information receiving section 231 of the control device 2 instructs the UI control section 233 to send, to the multifunction device 1, data of a notification screen showing a message “logging in . . . ”, with reference to the event table shown in FIG. 25 (S55), and the information receiving section 231 also instructs the application instruction section 236 to call an authentication application (S56).

As a result, in accordance with the instruction in the step S55, the UI control section 233 reads out, from the screen data storage section 232, the data of the notification screen showing the message “logging in . . . ”, and sends the data to the multifunction device 1 (S57). Receiving the data of the notification screen, the UI manager 16a of the multifunction device 1 causes the operation panel 6 to display the notification screen corresponding to the supplied data.

On the other hand, in response to the instruction in the step S56, the application instruction section 236 instructs the application section 25 to execute a process based on the authentication application program. In response, the application section 25 performs, based on the authentication application program, the authentication process of the user, by using an authentication database which has been registered in advance (S58).

After the authentication of the user is successfully done, the application section 25 instructs the multifunction device function control section 235 to send, to the multifunction device 1, an authentication success notification which indicates that the authentication has successfully been done (S59). In response, the multifunction device function control section 235 sends the authentication success notification to the multifunction device 1 (S60).

Furthermore, the multifunction device function control section 235 sends, to the multifunction device 1, a control instruction which instructs to change an operation screen (S62). If the authenticated user is an administrator, the multifunction device function control section 235 instructs the multifunction device 1 to request data of an administration menu screen. On the other hand, if the authenticated user is a general user, the multifunction device function control section 235 instructs the multifunction device 1 to request data of an process menu screen.

If the authentication is failed in the step S58, the operation panel 6 of the multifunction device 1 displays an error screen which indicates that the authentication has been failed.

Data communications in the steps S60 and S62 are carried out by means of SOAP.

(Maintenance Process of Program for Multifunction Device)

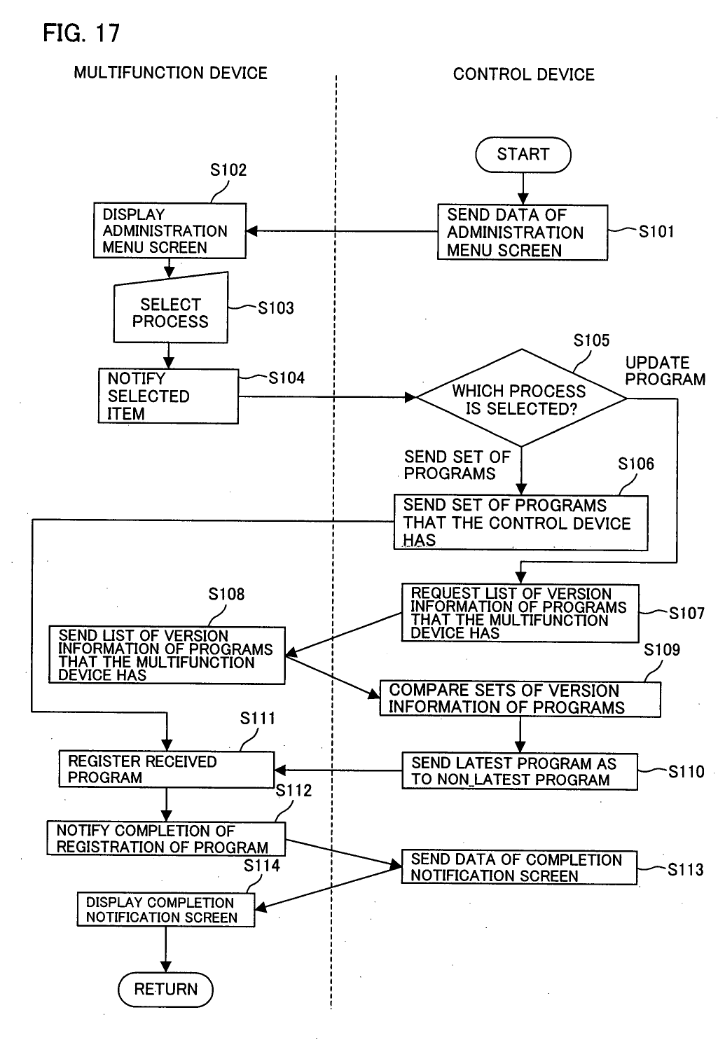

First, details of a maintenance process of a program for multifunction device in the step S3 shown in FIG. 10 will be given. FIG. 17 is a flowchart showing the maintenance process.

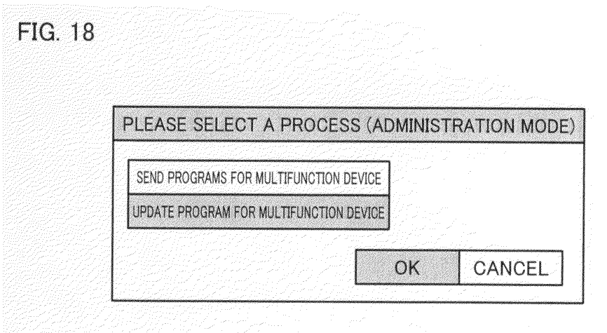

If in the step S58 the authenticated user is an administrator, the UI control section 233 of the control device 2 reads out, from the screen data storage section 232, data of an administration menu screen, and sends the data to the multifunction device 1 (S101). The administration menu screen lists items of administration that the user can selects. In the present embodiment, as shown in FIG. 18, the administration menu screen shows the following two selection items: (i) “multifunction device programs sending” to send, from the control device 2 to the multifunction device 1, all application programs for multifunction device; and (ii) “multifunction device program update” to update application programs stored in the multifunction device 1.

Subsequently, the UI manager 16a of the multifunction device 1 receives the data of the administration menu screen, and causes the operation panel 6 to display the administration menu screen corresponding to the data (S102). With reference to the administration menu screen, the user selects a desired processing item, i.e. the item (i) or (ii), by using the operation panel 6 or the input section 5 (S103). As a result, the UI manager 16a of the multifunction device 1 obtains information (selected item information) by which the item selected by the user is specified. It is noted that the selected item information is obtained as push button information.

Then the UI manager 16a of the multifunction device 1 sends the selected item information to the control device 2 so as to notify the control device 2 of the content of the process selected by the user (S104). In response, the information receiving section 231 of the control device 2 receives the selected item information and interprets the supplied information as a request to transmit a program for multifunction device, and judges which one of the items (i) and (ii) is desired by the user (S105).

In case where the selected item information supplied from the multifunction device 1 requests to execute the item (i), the information receiving section 231 instructs the multifunction device program sending section 237 to send a set of programs for multifunction device to the multifunction device 1. Then the flow proceeds to the step S106.

In the step S106, the multifunction device program sending section 237 reads out all programs for multifunction device from the transmission program storage section 238 and sends the programs to the multifunction device 1, along with an instruction to execute a process to register the programs. The process then proceeds to the step S111.

In the step S111, the job manager 17b of the Web service layer 17 in the multifunction device 1 receives, from the control device 2, the instruction to execute the process to register the programs, whereas the data transmission manager 17f receives the programs for multifunction device from the control device 2.

In response to the execution instruction, the job manager 17b calls a program registration management application 18h of the OSA application layer 18, and instructs the application 18h to register the programs for multifunction device, which has been received by the data transmission manager 17f. In response, the program registration management application 18h receives the program for multifunction device from the data transmission manager 17f and stores the program in the storage section 105, and also the program registration management application 18h registers that program so that the job manager 17b is able to call the program as an application of the OSA application layer 18 (S111).

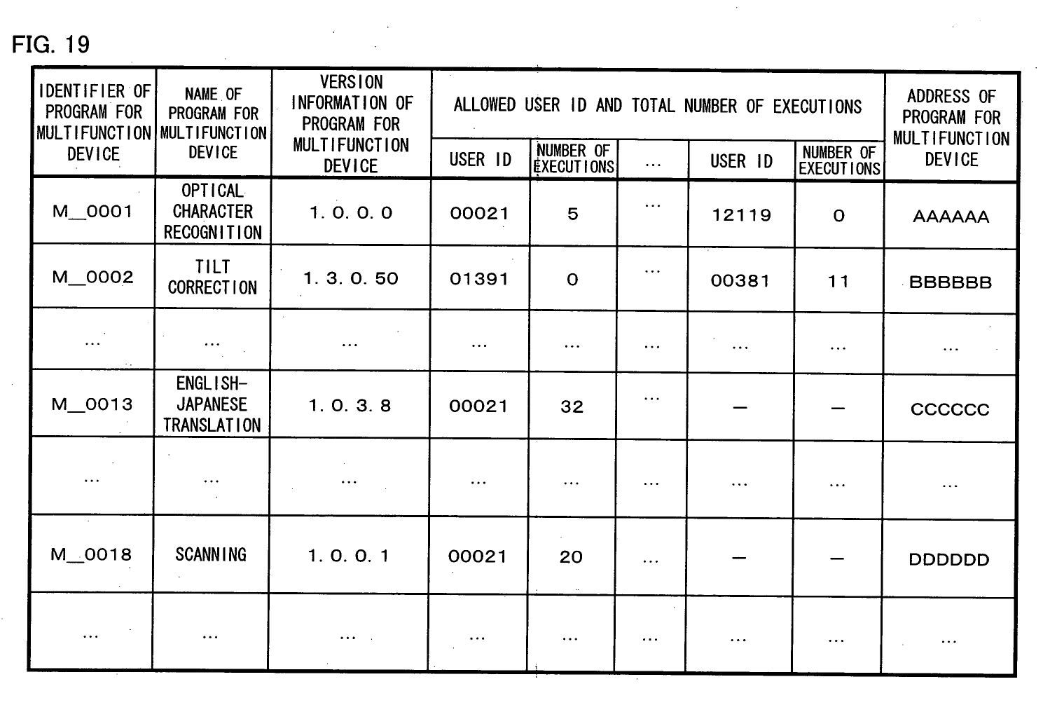

The registration is carried out in such a manner that the program registration management application 18h updates a program management table stored in the storage section 105. FIG. 19 shows an example of the program management table. The program management table stores the following items for each program for multifunction device: the identifier of the program, the name of the program, the version information of the program, the ID of the user who can execute the program, the total number of times that the program is executed by the user, and the address of the program.

With reference to the program management table, the program registration management table 18h judges whether the supplied program for multifunction device is a new program. If the supplied program is a new program, the program registration management application 18h adds the data of the supplied program to the program management table program. On the other hand, in case where the supplied program for multifunction device has already been registered, the program registration management application updates the data corresponding to the program in the table.

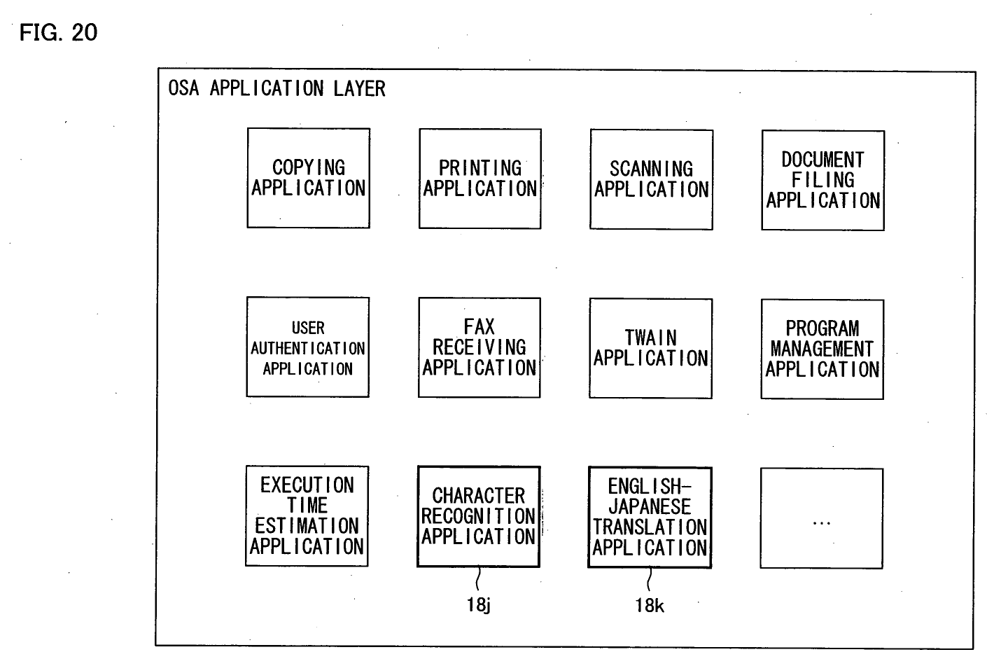

The job manager 17b of the Web service layer 17 calls an application of the OSA application layer 18 with reference to the above-described program management table. On this account, since the program registration management application 18h updates the program management table, a program for multifunction device, which is supplied from the control device 2, can be called. For example, in the step S111, if an optical character recognition program and an English-Japanese translation program are newly registered, the OSA application layer 18 of FIG. 1 is changed as shown in FIG. 20.

On the other hand, if in the step S105 the information supplied from the multifunction device 1 requests the item (ii), the information receiving section 231 instructs the multifunction device program sending section 237 to send the updated program for multifunction device to the multifunction device 1, and then the flow proceeds to the step S107.

In the step S107, the multifunction device program sending section 237 sends, to the multifunction device 1, a request of version list information which indicates the version information of all programs stored in the storage section 105 of the multifunction device 1. The job manager 17b of the Web service layer 17 of the multifunction device 1 receives the request of version list information from the control device 2 and instructs the program registration management application 18h of the OSA application layer 18 to send the version list information.

Receiving the instruction, the program registration management application 18h extracts the version information of the programs from the aforesaid program management table, and generates the version list information indicating the list of version information of all programs that the multifunction device 1 has. The program registration management application 18h then sends the version list information to the control device 2 via the Web service layer 17 (S108). The information receiving section 231 of the control device 2 receives the version list information, and inputs the information in the multifunction device program sending section 237.

Subsequently, the multifunction device program sending section 237 compares the version list information supplied from the multifunction device 1 with the multifunction device program management table (see FIG. 7) stored in the transmission program storage section 238 (S109). If it is found that a program in the control device 2 is a newer version than the program in the multifunction device 1, the multifunction device program sending section 237 reads out that program from the transmission program storage section 238.

The multifunction device program sending section 237 then sends the program for multifunction device, which has been read out, to the multifunction device 1. Along with the program, an instruction to execute the registration of the program is also sent. The flow then proceeds to the step S111 and the registration of the program is carried out.

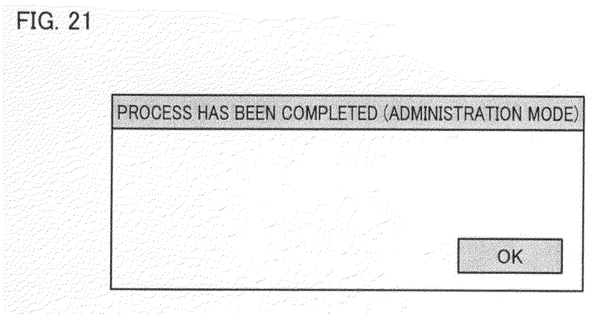

When the registration of the program is carried out in the step S111, the program registration management application 18h notifies the control device 2 of the completion of the registration of the program, via the Web service layer 17 (S112). In response to this, the UI control section 233 of the control device 2 sends, to the multifunction device 1, the data of the completion notification screen which is shown in FIG. 21 and indicates that the process has been completed (S113), and the UI manager 16a of the multifunction device 1 displays the completion notification screen on the operation panel 6 (S114).

(Cooperated Process in Multifunction Device)

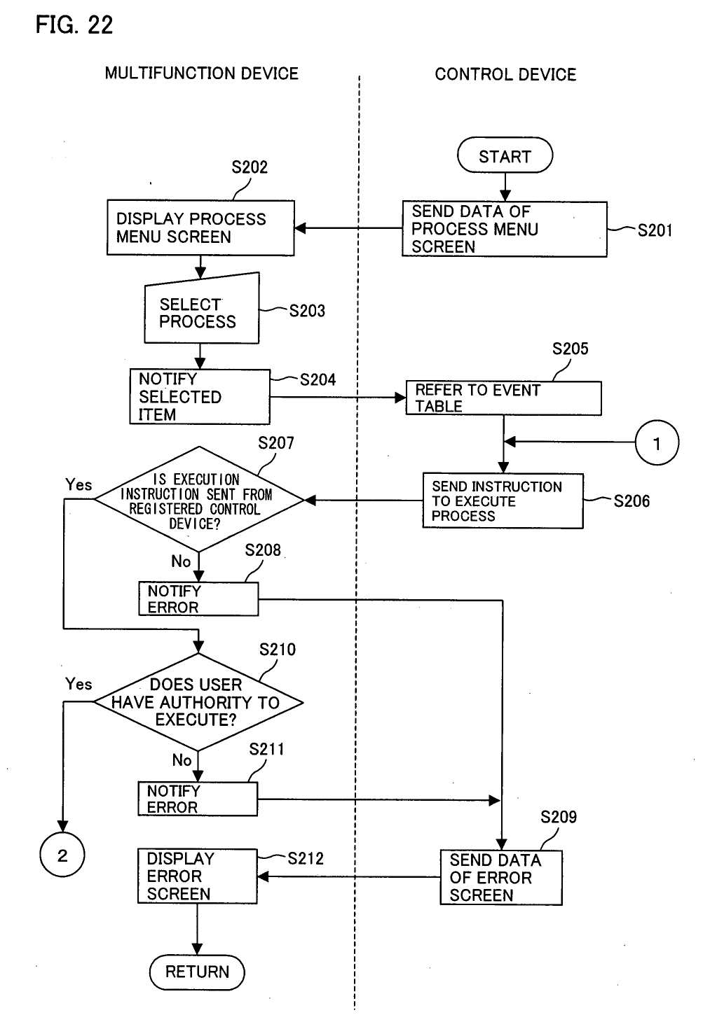

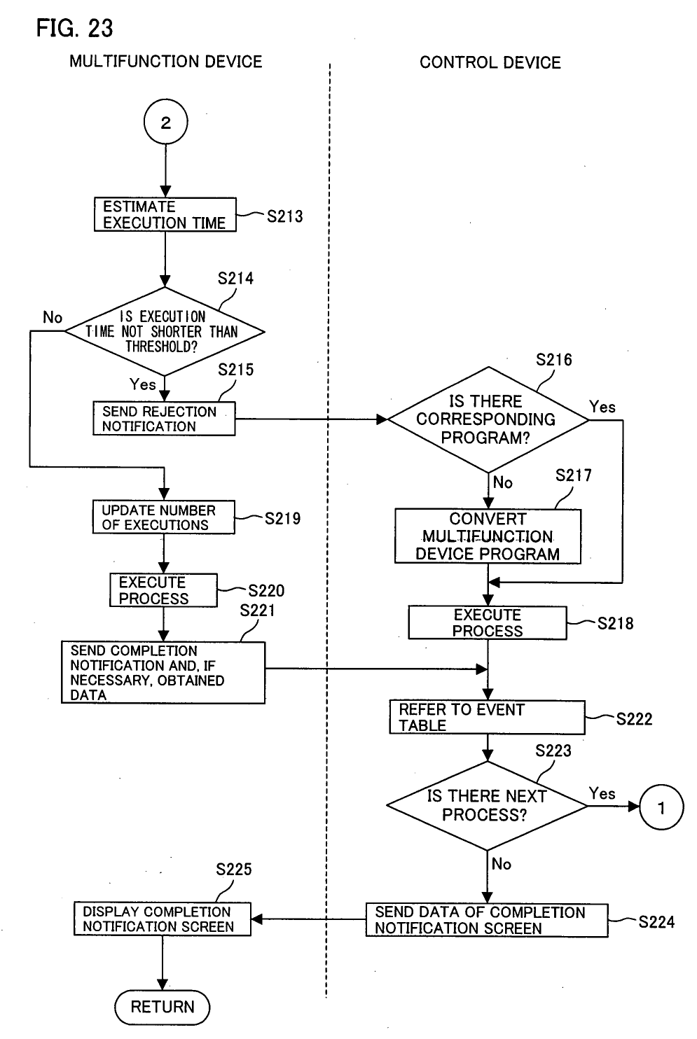

Now, details of cooperated processes performed by the multifunction device 1 in the step S4 shown in FIG. 10 will be given. FIGS. 22 and 23 are flowcharts showing the cooperated process in the multifunction device 1.

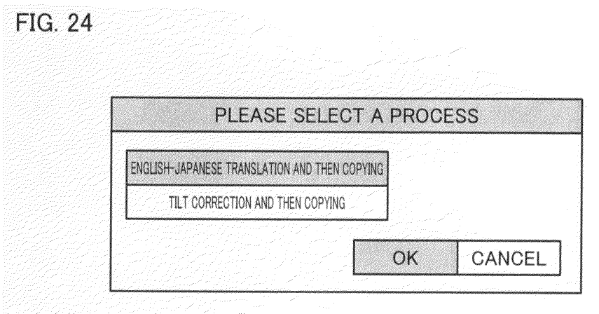

When the user authenticated in the step S58 is a general user, the UI control section 233 of the control device 2 reads out the data of the process menu screen from the screen data storage section 232, and sends the data to the multifunction device 1 (S201). The process menu screen lists items that the user can select. FIG. 24 shows an example of the process menu screen.

The UI manager 16a of the multifunction device 1 receives the data of the process menu screen and causes the operation panel 6 to display the process menu screen corresponding to the data (S202). With reference to this process menu screen, the user then selects a desired item by using the operation panel 6 or the input section 5 (S203). As a result, the UI manager 16a of the multifunction device 1 obtains information (selected item information) by which the item selected by the user is specified. The selected item information is obtained as push button information.

Subsequently, the UI manager 16a of the multifunction device 1 sends the selected item information to the information receiving section 231 of the control device 2, so as to notify the control device 2 of the content of the process selected by the user (S204). In response, with reference to the event table shown in FIG. 25, the information receiving section 231 instructs the multifunction device function control section 235 to send an appropriate execution instruction to the multifunction device 1, which instruction corresponds to the process selected by the user (S205).

For example, when an “English-Japanese translation and copying” process in the process menu screen in FIG. 24 is selected, the information receiving section 231 refers to the event table and instructs the multifunction device function control section 235 to send an instruction to execute scanning to the multifunction device 1. The following assumes that the “English-Japanese translation and copying” process in the process menu screen is selected.

Subsequently, in response to the instruction from the information receiving section 231, the multifunction device function control section 235 sends, to the job manager 17b of the multifunction device 1, the instruction to execute the process, the ID of the user who has been authenticated in the step S58, and the identification information of the control device 2 which has sent the instruction (S206). If the process to be executed requires data (e.g. OCR process, translation process, printing process), the multifunction device function control section 235 sends the data (hereinafter, input data) to the data transmission manager 17f of the multifunction device 1. It is noted that transmission of data such as an execution instruction in the step S206 is carried out based on SOAP.

This step may be illustrated as follows, in the case of the example above. The multifunction device function control section 235 reads out, from the control instruction table storage section 234, execution instructions (“JobCreate”, “ExecuteScan”, and “JobClose”) for the scanning process, adds the user ID and the identification information of the control device 2 to the execution instructions, and sends them to the Web service layer 17 of the multifunction device 1.

Thereafter, the job manager 17b of the Web service layer 17 receives the execution instructions, user ID, and the identification of the control device, and determines if these execution instructions are supplied from a control device 2 which has been registered in advance (S207). That is to say, in the multifunction device 1 of the present embodiment, the storage section 105 stores control device restriction information which lists sets of identification information of control devices whose execution instructions are acceptable, and the job manager 17b determines whether the identification information of the control device, which has been supplied along with the execution instructions, has been registered in the control device restriction information.

If the supplied identification information is not registered in the control device restriction information, the job manager 17b judges that the supplied execution instructions are not valid and notifies the control device 2 of error (S208). As a result, in the control device 2, in accordance with the instruction from the information receiving section 231, the UI control section 233 sends data of an error screen to the multifunction device 1 (S209), and the operation panel 6 of the multifunction device 1 displays the error screen (S212).

On the other hand, if in the step S207 the supplied identification information has been registered in the control device restriction information, the job manager 17b determines whether the user indicated by the user ID supplied along with the execution instructions has been authenticated to execute the program used for the process based on the execution instructions, with reference to the aforesaid program management table shown in FIG. 19 (S210).

In the aforesaid example, the execution instruction “ExecuteScan” instructs to execute a “scanning” program indicated by the identifier “M_{—}0018” in the program management table shown in FIG. 19. The job manager 17b determines whether the user ID supplied along with the execution instructions is included in executable user IDs designated in the row of the “scanning” program.

If the user having the supplied user ID does not have authority to execute the program used for the process based on the execution instructions, the job manager 17b notifies the control device 2 of error (S211). As a result, in the control device 2, the UI control section 233 sends the data of the error screen to the multifunction device 1 in response to an instruction from the information receiving section 231 (S209), and the operation panel 6 of the multifunction device 1 displays the error screen (S212).

In the meanwhile, if in the step S210 the user indicated by the supplied user ID is authenticated to execute the program, the job manager 17a calls an execution time estimation application 18i of the OSA application layer 18. The execution time estimation application 18i then estimates how long it takes to execute the process based on the execution instructions (i.e. estimates an execution time of the program) (S213).

For example, in case where the execution instructions from the control device 2 indicate an English-Japanese translation process, time required for the process depends on an amount of texts to be translated. While the multifunction device 1 is translating a large amount of texts, the user cannot execute processes other than the translation. For this reason, the execution time estimation application 18i estimates time required for the process, and whether or not the process is to be executed is determined based on the result of the estimation.

It is assumed that time required for a process depends on the size of data to be processed, for example, an amount of texts to be translated, in a case of English-Japanese translation. Therefore, the execution time estimation application 18i estimates time required for a process based on input data that the data transmission manager 17f receives when the job manager 17b receives an execution instruction.

For example, provided that the size of input data is N and a parameter which is determined for each processing content (application program) is A, the execution time T is determined by one of the following equations (1)-(4).

T=A×N (1)

T=A×NlogN (2)

T=A×N² (3)

T=A×2^{N} (4)

As a matter of course, one of the equations (1)-(4) may be selected in accordance with the type of a process to be executed, for example, a translation process, an OCR process, and a translation process.

In case where there is no input data, e.g. in case of a scanning process, the step of estimating processing time may be omitted, estimation time may be estimated by another method, or predetermined time may be set as processing time.

Subsequently, the execution time estimation application 18i determines whether the estimated processing time is not shorter than a threshold (S214). The threshold may be fixed in advance or may be varied in accordance with, for example, a amount of jobs which have been registered in the multifunction device 1.

If the estimated processing time is shorter than the threshold, the job manager 17b updates the accumulated number of executions of an application (program) called in accordance with the execution instruction, in the program management table shown in FIG. 19 (S219). More specifically, since the program management table stores the accumulated number of executions for each user, the job manager 17b increments the accumulated number of executions, which corresponds to the user ID supplied in the step S206.

Thereafter, the job manager 17b calls an application to perform the process in accordance with the execution instruction. As a result, the process based on the execution instruction is performed (S220).

In the case of aforesaid example, receiving an execution instruction “ExecuteScan” to perform scanning, the job manager 17b calls a scanning application 18c from the OSA application layer 18. Calling the scanning application 18c indicates that the job manager 17b causes the CPU 101 to execute a “scanning” program with reference to the program management table shown in FIG. 19.

As a matter of course, when the job manager 17b receives an instruction to execute the character recognition process or the English-Japanese translation process, either a character recognition application 18j or an English-Japanese translation application 18k, which is newly added in FIG. 20, may be called (i.e. the CPU 101 is instructed to execute an “optical character recognition” program or an “English-Japanese translation” program supplied from the control device 2).

In the OSA application layer 18 and the layers below the same, an instructed process is executed principally by the following two methods. First, in case where an instructed process is executable by hardware of only the CPU 101 and the storage section 105, for example, the character recognition process and the translation process, an application in the OSA application layer executes the process.

On the other hand, in case where hardware other than the control section 100 and the storage section 105 is required, for example the scanning process and the printing process, an application called from the OSA application layer 18 calls a service of the service layer 13 via the Open I/F layer 19. Then the service called from the service layer 13 calls a driver from the driver layer 14, which driver controls desired hardware, and the service executes the process.

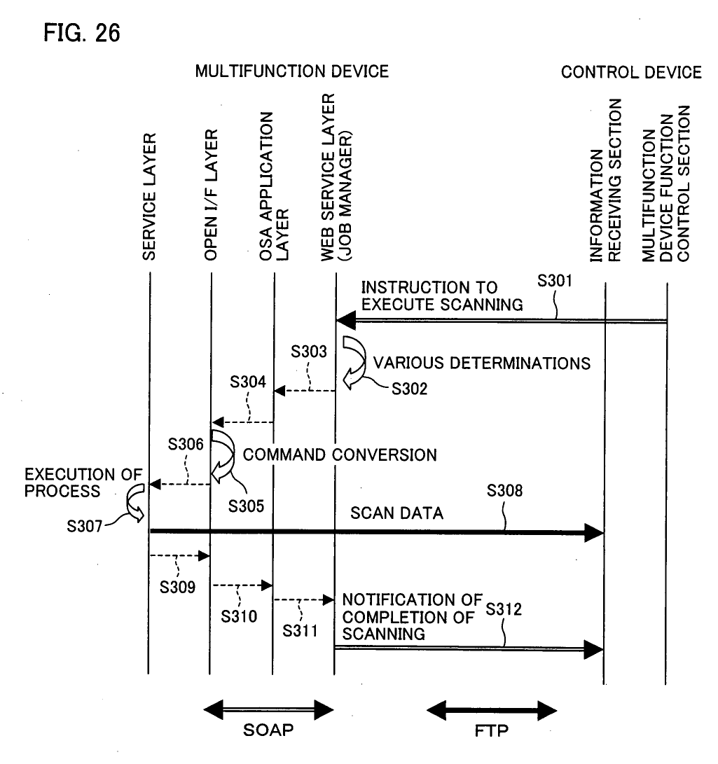

For example, as shown in FIG. 26, in case where an instruction to execute the scanning process is supplied from the control device 2 (S301) and the scanning application 18c is called from the OSA application layer 18 (S303), the scanning application 18c outputs the first control command “ExecuteScan” to the Open I/F layer 19 (S304).

In response, with reference to a command correspondence table shown in FIG. 8, the Open I/F layer 19 serially sends, to the service layer 13, second control commands “Do Scan”, “Save File”, and “Send By FTP” corresponding to the supplied first control command “ExecuteScan” (S306). As a result, in response to the second control command “Do Scan”, a scanning service 13a of the service layer 13 is called. This scanning service 13a calls a driver to control the document reading section 110 from the driver layer 14 and executes reading of a document (S307). Thereafter, a file service 13e stores, as a file, the data obtained from the document. Finally, a network service 13g sends the stored file to the control device 2 by means of FTP (S308).

Subsequently, a completion notification which indicates the completion of the process is supplied from the service layer 13 to the Open I/F layer 19, to the OSA application layer 19, and then to the Web service layer 17. The event manager 17c of the Web service layer 17 sends the completion notification to the information receiving section 231 of the control device 2 (S221 in FIG. 23 and S309-S312 in FIG. 26). The completion notification is sent by means of SOAP.

Receiving the completion notification of the process, the information receiving section 231 of the control device 2 refers to the event table (S222) and determines whether there is a next process to be executed without a break (S223). If there is a next process, the flow goes back to the step S206 and the multifunction device function control section 235 sends an instruction to execute the next process, in response to an instruction from the information receiving section 231. If there is data required for executing the process, the multifunction device function control section 235 sends the data to the data transmission manager 17f of the multifunction device 1.

For example, when the user selects an “English-Japanese translation and copying” process and the multifunction device 1 finishes the scanning process, the information receiving section 231 refers to the event table shown in FIG. 25 and instructs the multifunction device function control section 235 to send, to the multifunction device 1, an instruction to execute the character recognition process which is the next process. In doing so, the scanning data which has been obtained is also sent to the data transmission manager 17f. Similarly, when the character recognition process is finished, the English-Japanese translation process is carried out, and when the English-Japanese translation process is finished, the printing process is carried out.

When all processes are completed in S223, the information receiving section 231 instructs the UI control section 233 to send, to the multifunction device 1, data of a completion notification screen which notifies that all processes are completed. In response, the UI control section 233 sends the data of the completion notification screen to the multifunction device 1 (S223).

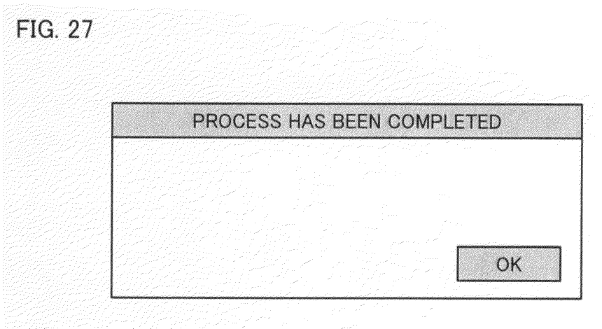

Then the UI manager 17a of the multifunction device 1 displays, on the operation panel 6, the completion notification screen corresponding to the supplied data (S224). FIG. 27 shows an example of the completion notification screen.

In the step S214, if the processing time estimated by the execution time estimation application 18i is not shorter than the threshold, the job manager 17b sends, to the information receiving section 231 of the control device 2, a rejection notification which notifies that the execution of the instructed process is rejected (S215). In doing so, the job manager 17b also sends an identifier of a program for multifunction device, which program corresponds to the rejected process.

Receiving the rejection notification, the information receiving section 231 instructs the application instruction section 236 to cause the application section 25 to execute the rejected process. In response, in order to execute the rejected process in the multifunction device 1, the application instruction section 236 determines whether a program for control device, which corresponds to the rejected program for multifunction device, exists in the storage section 135 of the control device 2 (S216).

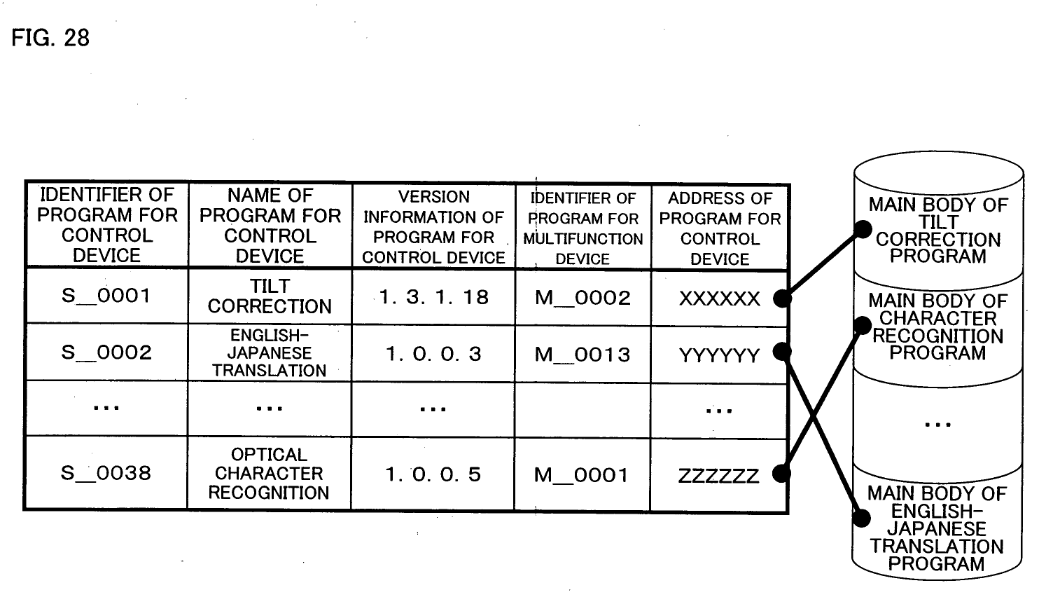

Details of this step will be given. The storage section 135 of the control device 2 of the present embodiment stores a control device program management table, which is shown in FIG. 28. This control device program management table shows information in regard to each application program stored in the storage section 135 of the control device 2 and executable by the CPU 131 of the control device 2. More specifically, the program management table lists, for each program, the identifier of the program, the name of the program, the version information of the program, the identification information of the corresponding program for multifunction device, and the address of the program.

Referring to this control device program management table, the application instruction section 236 determines whether the identification information of the program for multifunction device, which information has been sent along with the rejection notification, is listed in the control device program management table. If listed, it is indicated that the program for executing the rejected process exists in the control device 2. The application instruction section 236 therefore refers to the address and calls the program for control device, which program corresponds to the rejected program for multifunction device. In other words, the application instruction section 236 causes the CPU 131 to execute the program for control device, which program corresponds to the rejected program for multifunction device. As a result, the application section 25 of the control device 2 executes the process in place of the multifunction device 1 (S218).

On the other hand, if the identification information of the program for multifunction device, which has been sent along with the rejection notification, is not listed in the table, the application instruction section 236 instructs the program conversion section 239 to convert the program for multifunction device, which is used for executing the rejected process, into a program for control device, which is executable by the CPU 131 of the control device 2.

In response, the program conversion section 239 reads out, from the transmission program storage section 238, the program for multifunction device, which is used for executing the rejected process, and converts the program thus read out into a program for control device (S217). It is noted that a program for multifunction device, which is used for the conversion, is not necessarily stored in the transmission program storage section 238, and may be supplied from the multifunction device 1 as necessity arises.

Provided that, for example, the program for multifunction device is coded in Java® whereas the program for control device is coded in a native code (machine language) of the CPU 131, the program coded in Java® is converted into a source code such as C++, and then a native code is generated by compiling the source code.

Then the program conversion section 129 stores the program for control device, which has been obtained by the conversion, and add information in regard of the stored program to the control device program management table. Subsequently, the program conversion section 239 instructs the application instruction section 236 to cause the CPU 131 to execute the stored program for control device (i.e. to cause the application instruction section 236 to call the program for control device).

As a result, the application section 25 of the control device 2 executes the process in place of the multifunction device 1 (S218).

The blocks in the multifunction device 1 and the control device 2 shown in FIGS. 1 and 6 may be realized by hardware logic. Alternatively, the blocks may be realized by software, with the use of the CPU 101, 131 as follows.

That is, the multifunction device 1 and the control device 2 may include members such as: a CPU 101, 131 that executes instructions of a control program realizing the functions; a ROM (Read Only Memory) 108, 137 or HDD (Hard Disk Drive) 108, 138 recording the program; a RAM (Random Access Memory) 107, 136 on which the program is executed; and a storage device (recording medium) 105, 135, 140 such as a memory, which stores the program and various kinds of data. The objective of the present invention can be achieved in the following manner: program code (e.g. an executable code program, intermediate code program, and source program) of the control program of the multifunction device 1 and the control device 2, the control program being software for realizing the functions, is recorded on a recording medium in a computer-readable manner, this recording medium is supplied to the multifunction device 1 and the control device 2, and the computer (or CPU or MPU) reads out the program code from the recording medium and execute the program.

Examples of such a recording medium include a tape, such as a magnetic tape and a cassette tape; a magnetic disk, such as a flexible disk and a hard disk; a disc including an optical disc, such as a CD-ROM/MO/MD/DVD/CD-R; a card, such as an IC card (inclusive of a memory card); and a semiconductor memory, such as a mask ROM, an EPROM (Erasable Programmable Read Only Memory), an EEPROM (Electrically Erasable Programmable Read Only Memory), or a flash ROM.

Alternatively, the control section 20 may be capable of being connected to a communications network, allowing the program code to be supplied via the communications network. Non-limiting examples of the communications network include the Internet, intranet, extranet, LAN, ISDN, VAN CATV network, virtual private network, telephone network, mobile communications network, and satellite communications network. Non-limiting examples of the transmission media composing the communications network are, wired media such as IEEE1394, USB, power line communication, cable TV lines, telephone lines, and ADSL lines, infrared light such as IrDA and remote controller, electric waves such as Bluetooth®, IEEE802.11, HDR, mobile telephone network, satellite connection, and terrestrial digital broadcasting network. It is also noted the present invention may be realized by a carrier wave or as data signal sequence, which are realized by electronic transmission of the program code.

As described above, a multifunction device 1 of the present embodiment includes a CPU 101 and is connected with and is able to communicate with a control device 2, and the multifunction device 1 is controlled by the control device 2. The multifunction device 1 is provided with: a storage section 105 which stores a program for multifunction device, which program is executable by the CPU 101; a program registration management application 18h which receives a program for multifunction device form the control device 2 and stores the program in the storage section 105; and a job manager 17b which causes the CPU 101 to execute the program stored in the storage section 105, in response to an execution instruction from the control device 2.

According to the arrangement above, the program registration management application 18h obtains, from the control device 2, a program that the multifunction device 1 does not have, and the obtained program is stored in the storage section 105. This allows the multifunction device 1 to obtain, from the control device, a program that the multifunction device 1 does not have, and also allows the multifunction device 1 to execute, based on the obtained program, a new process which was not executable at the time of shipment. The job manager 17b causes the CPU 101 to execute the program for multifunction device, which program is stored in the storage section 105, in response to an execution instruction from the control device 2. This allows the control device 2 to give an instruction to execute a process based on the program that the multifunction device 1 has obtained. It is therefore possible to realize a system which can control functions of the multifunction device in an integrative manner and flexibly change the functions of the multifunction device.

The control device 2 of the present embodiment is connected to and able to communicate with the multifunction device 1 above, and includes: a transmission program storage section 238 which stores a program for multifunction device; a multifunction device program sending section 237 which reads out a program for multifunction device from the transmission program storage section 238 and sends the program to the multifunction device 1; and a multifunction device function control section 235 which sends, to the multifunction device 1, an instruction to execute the program sent by the multifunction device program sending section 237.

According to the arrangement above, the multifunction device program sending section 237 reads out a program for multifunction device from the transmission program storage section 238 and sends the program to the multifunction device 1. This allows the multifunction device 1 to obtain, from the control device, a program that the multifunction device 1 does not have, and hence the multifunction device 1 can execute a new process which could not be executed at the time of shipment. Also, the multifunction device function control section 235 sends, to the multifunction device 1, an instruction to execute the program for multifunction device, which program is sent by the multifunction device program sending section 237. This allows the control device 2 to instruct the execution of the program sent from the control device 2. It is therefore possible to realize a system which can control functions of the multifunction device in an integrative manner and flexibly change the functions of the multifunction device.

The number of control device 2 connected to the multifunction device 1 may be more than one. A control device which sends a program for multifunction device to the multifunction device 1 may be different from a control device which sends an instruction to execute the program.

In addition to a program for multifunction device, which is sent by the multifunction device program sending section 237, the multifunction device function control section 235 of the control device 2 sends an instruction to execute a program which is not sent by the multifunction device program sending section 237 but has been stored in the multifunction device 1.

According to the arrangement above, the control device 2 can send not only an instruction to execute a program which was not provided in the multifunction device 1 at the time of shipment and has been supplied by the control device 2 but also an instruction to execute a program which has been provided in the multifunction device 1 from the start. The control device 2 can therefore cause the multifunction device 1 to perform a cooperated process in which a process based on a program that the multifunction device 1 has had is combined with a process based on a program supplied from the control device 2. On this account, by changing the combination, it is possible to cause the multifunction device 1 to execute various cooperated processes.

The storage section 105 of the multifunction device 1 of the present embodiment stores control device restriction information indicating identification information of a control device which is allowed to send an execution instruction, and the job manager 17b receives the identification information of the control device which has sent the execution instruction. The job manager 17b then determines whether the control device 2 indicated by the supplied identification information is included in the control devices whose identification information is included in the control device restriction information. If it is determined that the control device is not included, the job manager 17b does not allow the CPU 101 to execute the program for multifunction device.

According to this arrangement, since the job manager does not allow an execution instruction from a control device whose identification information is not included in the control device restriction information, it is possible to prevent the multifunction device 1 from accepting an execution instruction from an unauthorized control device.

Similarly, in the multifunction device program management table stored in the storage section 105 of the multifunction device 1 of the present embodiment, as shown in FIG. 19, user IDs of users whose execution instruction is allowable are shown for each program for multifunction device. The job manager 17b receives the user ID of the user who has input to the operation panel 6 an instruction to execute the program for multifunction device. The job manager 17b determines whether the user ID supplied along with the execution instruction of the program for multifunction device is included in the user IDs of the users whose instruction to execute the program is allowable. If it is determined that the user ID is not included, the job manager 17b does not allow the CPU 101 to execute the program for multifunction device.

According to the arrangement above, since the job manager 17b does not allow an execution instruction from a user whose identification is not included in user restriction information, it is possible to prevent an unauthorized user from instructing the multifunction device 1 to execute a program for multifunction device. Furthermore, since the multifunction device program management table shows, for each program for multifunction device, user IDs of users whose execution instruction is allowable, it is possible to customize each user's authority to execute a program for multifunction device.

The multifunction device 1 of the present invention is arranged such that the job manager 17b counts how many times a program for multifunction device is executed by the CPU 101 for each program or each user, and stores, for each user or each program for multifunction device, the counted number of executions in the multifunction device program management table.

According to the arrangement above, it is possible to grasp how many times each program for multifunction device is executed by the multifunction device 1. This can be used for constructing an accounting system or taking statistics of the user of each program for multifunction device.

A specific example of the accounting system is such that the multifunction device 1 is provided with an accounting information processing section (accounting information processing means) which figures out accounting information which indicates price for use of the program, based on the number of executions counted by the job manager 17b. In this case, for each program for multifunction device, the accounting information processing section has unit price information indicating price for each use of the program for multifunction device, and accounting information by which the user is charged is obtained by multiplying the unit price by the counted number of executions. The job manager 17b may count the number of executions between settlements by resetting the counted number of executions each time the user makes settlement.

Another specific example of the accounting system is such that payment is made by the user in advance by means of, for example, a prepaid card, and the maximum number of executions is set in accordance with the payment. In such a case, the job manager 17b is arranged such that the CPU 101 is not allowed to execute a program for multifunction device when the number of executions has reached the aforesaid maximum. The job manager 17b may count the number of executions between settlements by resetting the counted number of executions each time the user makes settlement

As shown in FIG. 19, the storage section 105 of the multifunction device 1 of the present embodiment stores version information of a program for multifunction device along with the program, and the program registration management application 18h sends, to the control device 2, the version information of the program for multifunction device, which program is stored in the storage section 195.

As shown in FIG. 7, the transmission program storage section 238 of the control device 2 of the present embodiment stores version information along with a program for multifunction device. The multifunction device program sending section 237 (i) receives, from the multifunction device 1, the version information of the program for multifunction device, which program has been stored in the multifunction device 1, (ii) compares the supplied version information with the version information of the program for multifunction device, which information has been stored in the transmission program storage section 238 of that control device 2, and (iii) when the version indicated by the version information stored in the transmission program storage section 238 is newer than the version indicated by the supplied version information, sends the program stored in the transmission program storage section 238 to the multifunction device 1.

According to this arrangement, among programs for multifunction device, which programs are stored in the transmission program storage section 238 of the control device 2, those programs whose versions are older than programs stored in the control device 2 are not supplied from the multifunction device program sending section 237 to the multifunction device 1. On this account, not all of programs for multifunction device, which programs are stored in the control device 2, are sent, and hence the update of programs is efficiently carried out.

The multifunction device 1 of the present embodiment is provided with an execution time estimation application 18i which estimates time required for execution of a program for multifunction device. The job manager 17b compares the time estimated by the execution time estimation application 18i with a threshold, and does not allow the CPU 101 to execute the program for multifunction device if the estimated time is longer than the threshold.

According to this arrangement, even if the control device 2 gives an instruction to execute a program, the CPU 101 does not execute the program if execution time estimated by the execution time estimation application 18i is longer than the threshold. This prevents the multifunction device 1 from being occupied for a long time by a process instructed over a network.

Also, when execution time estimated by the execution time estimation application 18i is longer than the threshold, the job manager 17b of the multifunction device 1 sends, to the control device 2, a rejection notification which indicates that the execution of the program for multifunction device has been rejected.

The control device 2 includes an application instruction section 236 which causes the CPU 131 to execute, in response to the rejection notification from the multifunction device 2, a program for control device, which program is equivalent to the rejected program for multifunction device and is executable by the CPU 131 of that control device 2.

More specifically, as shown in FIG. 28, the storage section 135 of the control device 2 stores a control device program management table, which indicates how identification information of programs for control device is associated with identification information of programs for multifunction device. With reference to the control device program management table, the application instruction section 236 specifies, in the programs for control device stored in the storage section 135, a program for control device, which program corresponds to the program for multifunction device having been rejected in the multifunction device 1. The application instruction section 236 then causes the CPU 131 of the control device 2 to execute the specified program.

According to the arrangement above, even if there are plural programs for multifunction device and corresponding programs for control device, it is possible to specify which program for control device corresponds to the program for multifunction device, with reference to the control device program management table, and hence the control device 2 can execute the process rejected in the multifunction device 1, in place of the multifunction device 1.

The control device 2 is further provided with a program conversion section 239 which converts a program for multifunction device into a program for control device, and stores the program generated as a result of the conversion in the storage section 135.

According to this arrangement, even if the control device 2 does not have the program for control device, which program corresponds to the program for multifunction device, the program conversion section 239 converts the program for multifunction device into the program for control device, and hence the control device 2 can execute the process which has been rejected in the multifunction device 1, in place of the multifunction device 1.

The multifunction device 1 of the present embodiment includes: a service layer 13 which executes processes including an image reading process, an image forming process, and a communication process; a Web service layer 17 which receives an instruction to execute a cooperated process in which an image reading process, an image forming process, and a communication process are combined; an OSA application layer 18 which outputs a first control command corresponding to the execution instruction received by the Web service layer 17; a storage section 105 which stores a command conversion table indicating how first control commands output from the OSA application layer 18 are associated with second control commands that the service layer 13 can receive; and an Open I/F layer 19 which specifies, with reference to the command conversion table, the second control command corresponding to the first control command which has been output from the OSA application layer 18, and sends the specified second control command to the service layer 13.

Since the detail of the service layer 13 typically depends on the hardware of the multifunction device 1, the service layer 13 is unique to each type of multifunction device 1. On this account, second control commands that the service layer 13 can accept are different depending on the type of multifunction device 1.

According to the arrangement above, the Open I/F layer 19 receives the first control commands, specifies, in the command conversion table, the second control command corresponding to the first control command, and outputs the specified second control command to the service layer 13. With this, even if second control commands depend on the type of multifunction device 1 as described above, first control commands that the Open I/F layer 19 can accept do not depend on the type of multifunction device 1.

With the arrangement above, when an external control device 2 controls the multifunction device 1, the control device 2 outputs, to the multifunction device 1, an execution instruction based on which a first control command independent of the type of multifunction device 1 is generated. As a result, even when a control device 2 instructs a multifunction device 1 to execute a new process, the control device 2 is developed so as to make an execution instruction based on which a first control command shared among all types of multifunction devices 1 is generated. This makes it possible to improve the efficiency in the development.

In the command conversion table, one first control command may associated with plural second control commands.

According to this arrangement, based on one first control command instructing to execute a cooperated process, plural elemental processes constituting the cooperated process are executed based on second control commands.

As described above, a multifunction device of the present invention includes: program receiving means for receiving a program for multifunction device from a control device and storing the program in a received program storage section; and program calling means for causing a computer to execute the program stored in the received program storage section, in response to an instruction from the control device to execute the program.

A method of controlling a multifunction device of the present invention includes the following steps: program receiving means receives a program for multifunction device from a control device and stores the program in a received program storage section; and program calling means causes a computer to execute the program stored in the received program storage section, in response to an instruction from the control device to execute the program for multifunction device.

In the meanwhile, a control device of the present invention includes: program sending means for reading out a program for multifunction device from a transmission program storage section and sending the program to a multifunction device; and multifunction device control means for sending, to the multifunction device, an instruction to execute the program sent by the program sending means.

A method of controlling a control device of the present invention includes the following steps: program sending means reads out a program for multifunction device from a transmission program storage section and sends the program to a multifunction device; and multifunction device control means sends, to the multifunction device, an instruction to execute the program sent by the program sending means.

A multifunction device control system of the present invention includes the aforesaid multifunction device and control device.

Therefore, as described above, it is possible to realize a system which can control functions of the multifunction device in an integrative manner and flexibly change the functions of the multifunction device.

A control device which sends the program for multifunction device may be different form a control device which sends the execution instruction.

The multifunction device of the present invention is preferably arranged such that the received program storage section stores, in association with the program for multifunction device stored therein, version information of that program for multifunction device, and before receiving the program for multifunction device from the control device, the program receiving means sends, to the control device, the version information stored in the received program storage section.

According to this arrangement, the program receiving means notifies the control device of the version information of the program for multifunction device, which program is stored in the received program storage section of the multifunction device. The control device receiving this version information can therefore determine whether the program for multifunction device is sent to the multifunction device, with reference to the supplied version information. Therefore, in case where the version of the program in the multifunction device is newer than that of the program stored in the control device, the control device needs not to send the program to the multifunction device. It is therefore possible to efficiently send and receive programs for multifunction device.

Preferably, the multifunction device of the present invention further includes: execution time estimation means for estimating time to execute the program for multifunction device; and determining means for comparing the execution time estimated by the execution time estimation means with a threshold and determining whether the program calling means allows the computer to execute the program, and the program calling means does not allow the computer to execute the program when the determination result by the determining means is “no”.

According to this arrangement, the execution time estimation means estimates time required for executing the program for multifunction device. Based on the time estimated by the execution time estimation means, the program calling means determines whether the computer is allowed to execute the program. This makes it possible to prevent the multifunction device from being occupied for a long period of time when the execution of the program for multifunction device supplied from the control device takes long time.

Preferably, the program calling means sends, to the control device, a rejection notification which indicates that the execution of the program for multifunction device has been rejected, in case where the result of determination by the determining means is “no”.

According to this arrangement, when the program for multifunction device is not executed by the multifunction device on account of the result of determination by the determining means, the program calling means sends, to the control device, the rejection notification indicating that the execution of the program has been rejected. Receiving the rejection notification, the control device can execute, by itself, a process similar to the process based on the rejected program, or instruct another multifunction device to execute the rejected program.

Preferably, in the multifunction device of the present invention, the program calling means also receives the identification information of the control device that has sent the execution instruction, the multifunction device further includes: a control device restriction information storage section which stores control device restriction information indicating identification information of control devices whose execution instruction is allowable; and determining means for determining whether the control device indicated by the identification information received by the program calling means is included in the control devices whose identification information is registered in the control device restriction information, and the program calling means does not allow the computer to execute the program for multifunction device, when the result of determination by the determining means is “no”.

According to this arrangement, since the program calling means does not allow an execution instruction from a control device whose identification information is not registered in the control device restriction information, it is possible to prevent the multifunction device from accepting an execution instruction from an unauthorized control device, and hence the security is improved.

The multifunction device of the present invention is preferably further provided with execution frequency counting means for counting how many times the program for multifunction device has been executed by the computer.

According to this arrangement, since the execution frequency counting means counts how many times the program for multifunction device has been executed, it is possible, for example, to make statistics based on the counted number or figure out accounting information.

In the case of the latter, for example, the multifunction device may be further provided with accounting information processing means for figuring out accounting information which indicates price for use of the program, based on the number of executions counted by the execution frequency counting means.

According to this arrangement, since the accounting information processing means automatically figures out accounting information which indicates price for use of the program, it is possible to easily charge the user for the price of the use of the program for multifunction device.

Alternatively, the program calling means may disallow the computer to execute the program for multifunction device, if the number of executions counted by the execution frequency counting means has reached a threshold.

According to this arrangement, the calling means can reject the execution of the program for multifunction device, when the number of executions has reached the threshold. It is therefore possible to easily construct a system which is arranged such that the price is paid by the user in advance and the execution of the program for multifunction device is allowed for the number of times corresponding to the price.

Preferably, in the multifunction device of the present invention, the program calling means also receives the identification information of the user who has instructed the control device to send the execution instruction, the multifunction device further includes: a user restriction information storage section which stores user restriction information indicating identification information of users whose execution instruction is allowable; and determining means for determining whether the user indicated by the identification information received by the program calling means is included in the users whose identification information is registered in the user restriction information, and the program calling means does not allow the computer to execute the program for multifunction device, if the result of determination by the determining means is “no”.

According to this arrangement, since the program calling means does not allow a user whose identification information is not registered in the user restriction information to make an execution instruction, it is possible to prevent the multifunction device from accepting an execution instruction from an unauthorized user, and hence the security is improved.

Preferably the multifunction device further includes execution frequency counting means for counting how many times the program for multifunction device is executed by the computer, based on the identification information of the user, which has been received by the program calling means.

According to this arrangement, since the execution frequency counting means counts, for each user, the number of executions of the program for multifunction device, it is possible, for example, to make statistics for each user based on the counted number or to figure out accounting information for each user.

The multifunction device of the present invention further includes: elemental process executing means for executing processes including a communication process and at least one of an image reading process and an image forming process; execution instruction receiving means for receiving, from said one or more control devices, an instruction to execute a cooperated process which is a combination of processes executable by the elemental process executing means; first control command output means for outputting a first control command which corresponds to the instruction that the execution instruction receiving means has received; a command correspondence information storage section which stores command correspondence information which indicates how first control commands that are output from the first control command output means are associated with second control commands that the elemental process executing means is able to receive; and control command conversion means for specifying, with reference to the command correspondence information, a second control command corresponding to the first control command having been output from the first control command output means, and supplying the specified second control command to the elemental process executing means.

For the image reading process, image forming process, and communication process, hardware resources such as a scanning, printer, and communication unit are prerequisite. Hardware resources are typically different among multifunction devices. For this reason, when the multifunction device executes a process requiring the hardware resources, it has conventionally been required to send an execution instruction corresponding to each multifunction device. In other words, it has been necessary to customize an execution instruction for each multifunction device.

According to the above-described arrangement of the present invention, the first control command output means receives an execution instruction. When a first control command is output based on the execution instruction, this first control command is converted by the command conversion means into a second control command that the elemental process executing means can receive. Since the multifunction device of the present invention is provided with the command conversion means, an execution instruction is shared among multifunction devices without customizing the instruction for each multifunction device, because a first control command is converted by the command conversion means into a second control command corresponding to the hardware resources of the multifunction device.

In other words, a first control command may be shared among multifunction devices, whereas a second control command may be different among multifunction devices.

In the command correspondence information, one first control command may be associated with plural second control commands. According to this arrangement, it is possible to cause the multifunction device to execute a combination of plural elemental processes, by a single first control command.

The control device of the present invention is preferably arranged such that the transmission program storage section also stores, in association with the program stored therein, version information of the program, and the program sending means (i) receives, from the multifunction device, version information of a program for multifunction device, which program is stored in the multifunction device, (ii) compares the supplied version information with the version information stored in the transmission program storage section, and (iii) sends the program stored in the transmission program storage section to the multifunction device, in accordance with a result of comparison (ii).

According to this arrangement, the transmission program storage section also stores version information of a program for multifunction device. The program sending means compares the version information supplied from the multifunction device with the version information stored in the transmission program storage section, and the program for multifunction device is sent in accordance with the result of the comparison. With this, when the multifunction device has already had a program for multifunction device, whose version is newer than that of the control device, the control device needs not to send the program to the multifunction device, and hence sending and receiving of programs for multifunction device can be efficiently done.

The control device of the present invention is preferably arranged such that, in addition to the instruction to execute the program that the program sending means sends, the multifunction device control means sends an instruction to execute a program for multifunction device, which program is stored in the multifunction device but is not sent by the program sending means.

According to this arrangement, the control device can send not only an instruction to execute a program which was not provided in the multifunction device at the time of shipment and is provided by the control device but also an instruction to execute a program that the multifunction device has had from the start. It is therefore possible to cause the multifunction device to execute a cooperated process in which a process based on the program that the multifunction device has had is combined with a process based on the program supplied by the control device. On this account, by changing the combination, it is possible to cause the multifunction device to execute various cooperated processes.

The control device of the present invention preferably includes: a computer; an execution program storage section which stores a program for control device, which program is executable by the computer of the control device; and program calling means for causing the computer of the control device to execute the program stored in the execution program storage means, when the program calling means receives a rejection notification which indicates that the multifunction device rejects execution of the program for multifunction device in accordance with the instruction sent by the multifunction device control means.

According to this arrangement, in case where the multifunction device rejects the execution of a program for multifunction device, which program has been sent from the control device, the program calling means reads out a program for control device from the execution program storage section and the computer of the control device is instructed to execute the program. For this reason, if a program for control device, which corresponds to the program for multifunction device, is stored in the execution program storage section, a process based on the program rejected in the multifunction device can be executed by the control device, in place of the multifunction device.

Preferably the control device further includes a program correspondence information storage section in which identification information of programs for control device is associated with identification information of programs for multifunction device, with reference to the program correspondence information storage section, the program calling means specifying, in the execution program storage section, a program for control device which program corresponds to the program rejected by the multifunction device, and the program calling means causes the computer of the control device to execute the specified program.

According to this arrangement, even if there are plural programs for multifunction device and corresponding programs for control device, it is possible to specify the program for control device, which corresponds to the program for multifunction device, with reference to the program correspondence information storage section. It is therefore possible to cause the control device to execute the process rejected in the multifunction device, in place of the multifunction device.

Preferably the control device further includes program conversion means for converting a program for multifunction device into a program for control device and stores the program generated as a result of the conversion in the execution program storage section.

According to this arrangement, even if the control device does not have the program for control device, which program corresponds to the program for multifunction device, the program conversion means converts the program for multifunction device into the program for control device, and hence the control device can execute the process which has been rejected in the multifunction device, in place of the multifunction device.

The present invention can be used for a multifunction device control system in which a multifunction device is connected with a control device via a communications network and the multifunction device is controlled.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A multifunction device which includes a computer, is connected to and is able to communicate with one or more control devices, and is controlled by said one or more control devices,
the multifunction device comprising:
a received program storage section which stores a program for multifunction device, the program being executable by the computer;
program receiving means for receiving the program from said one or more control devices and storing the program in the received program storage section; and
program calling means for causing the computer to execute the program stored in the received program storage section, in response to an instruction to execute the program, the instruction being supplied from said one or more control devices.

2. The multifunction device as defined in claim 1,
wherein, among said one or more control devices, a control device which sends the program for multifunction device is different from a control device which sends the instruction.

3. The multifunction device as defined in claim 1,
wherein, the received program storage section also stores, in association with the program stored therein, version information of that program, and
before receiving the program from said one or more control devices, the program receiving means sends, to said one or more control devices, the version information stored in the received program storage section.

4. The multifunction device as defined in claim 1, further comprising:
execution time estimation means for estimating execution time of the program; and
determining means for determining whether the program calling means is allowed to cause the computer to execute the program, by comparing the execution time estimated by the execution time estimation means with a threshold,
if the determining means disallows execution of the program, the program calling means not causing the computer to execute the program.

5. The multifunction device as defined in claim 4,
wherein, if the determining means disallows execution of the program, the program calling means sends, to said one or more control devices, a rejection notification which indicates that execution of the program has been rejected.

6. The multifunction device as defined in claim 1,
wherein, the program calling means also receives identification information of a control device that has sent the instruction,
the multifunction device further comprising:
control device restriction information storage section which stores control device restriction information which indicates identification information of control devices which are allowed to send the instruction; and
determining means for determining whether the control device indicated by the identification information that the program calling means has received is included in the control devices whose identification information is registered in the control device restriction information,
if the determining means determines that the control device indicated by the identification information is not included, the program calling means not causing the computer to execute the program.

7. The multifunction device as defined in claim 1, further comprising execution frequency counting means for counting how many times the program has been executed by the computer.

8. The multifunction device as defined in claim 7, further comprising accounting information processing means for figuring out accounting information which indicates price for use of the program, based on the number of executions counted by the execution frequency counting means.

9. The multifunction device as defined in claim 7,
wherein, if the number of executions counted by the execution frequency counting means has reached a threshold, the program calling means does not cause the computer to execute the program.

10. The multifunction device as defined in claim 1,
wherein, the program calling means also receives identification information of a user who has instructed the control device to send the instruction,
the multifunction device further comprising:
user restriction information storage section which stores user restriction information indicating identification information of users who are allowed to issue the instruction; and
determining means for determining whether the user indicated by the identification information that the program calling means has received is included in the users whose identification information is registered in the user restriction information storage section,
if the determining means determines that the user indicated by the identification information is not included, the program calling means not causing the computer to execute the program.

11. The multifunction device as defined in claim 10, further comprising execution frequency counting means for counting, for each user, how many times the program has been executed by the computer, based on the identification information, of the user, which has been received by the program calling means.

12. The multifunction device as defined in claim 1, further comprising:
elemental process executing means for executing processes including a communication process and at least one of an image reading process and an image forming process;
execution instruction receiving means for receiving, from said one or more control devices, an instruction to execute a cooperated process which is a combination of processes executable by the elemental process executing means;
first control command output means for outputting a first control command which corresponds to the instruction that the execution instruction receiving means has received;
a command correspondence information storage section which stores command correspondence information which indicates how first control commands that are output from the first control command output means are associated with second control commands that the elemental process executing means is able to receive; and
control command conversion means for specifying, with reference to the command correspondence information, a second control command corresponding to the first control command having been output from the first control command output means, and supplying the specified second control command to the elemental process executing means.

13. The multifunction device as defined in claim 12,
wherein, the first control commands are shared among multifunction devices, whereas the second control commands are different among the multifunction devices.

14. The multifunction device as defined in claim 12,
wherein, in the command correspondence information, the first control command is associated with plural second control commands.

15. A control device which is connected with and able to communicate with a multifunction device including a computer,
the control device comprising:
a transmission program storage section which stores a program for multifunction device, the program being executable by the computer of the multifunction device;
program sending means for reading out the program from the transmission program storage section and sending the program to the multifunction device; and
multifunction device control means for sending, to the multifunction device, an instruction to execute the program which is sent by the program sending means.

16. The control device as defined in claim 15,
wherein, the transmission program storage section also stores, in association with the program stored therein, version information of that program, and
the program sending means (i) receives, from the multifunction device, version information of a program for multifunction device, which program is stored in the multifunction device, (ii) compares the supplied version information with the version information stored in the transmission program storage section, and (iii) sends the program stored in the transmission program storage section to the multifunction device, in accordance with a result of comparison (ii).

17. The control device as defined in claim 15,
wherein, in addition to the instruction to execute the program that the program sending means sends, the multifunction device control means sends an instruction to execute a program for multifunction device, which program is stored in the multifunction device but is not sent by the program sending means.

18. The control device as defined in claim 15, further comprising:
a computer;
an execution program storage section which stores a program for control device, which program is executable by the computer of the control device; and
program calling means for causing the computer of the control device to execute the program stored in the execution program storage means, when the program calling means receives a rejection notification which indicates that the multifunction device rejects execution of the program for multifunction device in accordance with the instruction sent by the multifunction device control means.

19. The control device as defined in claim 18, further comprising a program correspondence information storage section in which identification information of programs for control device is associated with identification information of programs for multifunction device,
with reference to the program correspondence information storage section, the program calling means specifying, in the execution program storage section, a program for control device which program corresponds to the program rejected by the multifunction device, and the program calling means causes the computer of the control device to execute the specified program.

20. The control device as defined in claim 18, further comprising program conversion means for converting a program for multifunction device into a program for control device and stores the program generated as a result of conversion in the execution program storage section.

21. A multifunction device control system comprising:
a multifunction device including a computer; and
one or more control devices which are connected to and able to communicate with the multifunction device,
each control device including:
a transmission program storage section which stores a program for multifunction device, the program being executable by the computer of the multifunction device;
program sending means for reading out the program from the transmission program storage section and sending the program to the multifunction device; and
multifunction device control means for sending, to the multifunction device, an instruction to execute the program which is sent by the program sending means,
the multifunction device including:
a received program storage section which stores the program for multifunction device;
program receiving means for receiving the program from said one or more control devices and storing the program in the received program storage section; and
program calling means for causing the computer to execute the program stored in the received program storage section, in response to the instruction from said one or more control devices.

22. A control program for causing a computer to function as means of a multifunction device which includes a computer, is connected to and is able to communicate with one or more control devices, and is controlled by said one or more control devices, the multifunction device including: a received program storage section which stores a program for multifunction device, the program being executable by the computer; program receiving means for receiving the program from said one or more control devices and storing the program in the received program storage section; and program calling means for causing the computer to execute the program stored in the received program storage section, in response to an instruction to execute the program, the instruction being supplied from said one or more control devices.

23. A computer-readable storage medium which stores a computer program for causing a computer to function as means of a multifunction device which includes a computer, is connected to and is able to communicate with one or more control devices, and is controlled by said one or more control devices, the multifunction device including: a received program storage section which stores a program for multifunction device, the program being executable by the computer; program receiving means for receiving the program from said one or more control devices and storing the program in the received program storage section; and program calling means for causing the computer to execute the program stored in the received program storage section, in response to an instruction to execute the program, the instruction being supplied from said one or more control devices.

24. A control program for causing a computer to function as means of a control device which is connected with and able to communicate with a multifunction device including a computer, the control device including: a transmission program storage section which stores a program for multifunction device, the program being executable by the computer of the multifunction device; program sending means for reading out the program from the transmission program storage section and sending the program to the multifunction device; and multifunction device control means for sending, to the multifunction device, an instruction to execute the program which is sent by the program sending means.

25. A computer-readable storage medium storing a control program for causing a computer to function as means of a control device which is connected with and able to communicate with a multifunction device including a computer, the control device including: a transmission program storage section which stores a program for multifunction device, the program being executable by the computer of the multifunction device; program sending means for reading out the program from the transmission program storage section and sending the program to the multifunction device; and multifunction device control means for sending, to the multifunction device, an instruction to execute the program which is sent by the program sending means.

26. A method of controlling a multifunction device which includes a computer, is connected with and able to communicate with one or more control devise, and is controlled by said one or more control devices,
the method comprising the steps of:
receiving a program for multifunction device from said one or more control device and storing the program in a received program storage section; and
in response to an instruction to execute the program, causing the computer to execute the program stored in the received program storage section.

27. A method of controlling a control device which is connected to and able to communicate with a multifunction device including a computer,
the method comprising the steps of:
reading out a program for multifunction device from a transmission program storage section and sending the program to the multifunction device; and
sending, to the multifunction device, an instruction to execute the program sent by program sending means.
